(19) United States
(12) Patent Application Publication
(10) Pub. No.: US 2013/0030919 A1
(43) Pub. Date: Jan. 31, 2013

(54) Targeting Listings Based on User-Supplied Profile and Interest Data

(71) Applicants: Robert Maddox Brinson, JR., Rome, GA (US); Madison Elizabeth Brinson, Rome, GA (US); Tina Brinson Cox, Rome, GA (US); Rebecca Frierson Maddox, Rome, GA (US); Hal Hunt Blakeslee, Hermosa Beach, CA (US)

(72) Inventors: Robert Maddox Brinson, JR., Rome, GA (US); Madison Elizabeth Brinson, Rome, GA (US); Tina Brinson Cox, Rome, GA (US); Rebecca Frierson Maddox, Rome, GA (US); Hal Hunt Blakeslee, Hermosa Beach, CA (US)

(21) Appl. No.: 13/560,124

(22) Filed: Jul. 27, 2012

Related U.S. Application Data
(60) Provisional application No. 61/512,580, filed on Jul. 28, 2011.

(51) Int. Cl. G06Q 30/02

(52) U.S. Cl. 705/14.58; 705/14.66

(57) ABSTRACT

Technologies for targeting listings based on user-supplied profile and interest data are presented herein. In one aspect, user-supplied profile and interest data is received from a user. Targeted business listings are generated for the user based on the user-supplied profile and interest data. The targeted business listings are then provided to the user.

### CROSS-REFERENCE TO RELATED APPLICATIONS

This application claims the benefit of U.S. Provisional Patent Application Ser. No. 61/512,580 filed on Jul. 28, 2011, entitled “Targeting Listings Based On User-Supplied Profile and Interest Data,” which is expressly incorporated herein by this reference in its entirety.

### BACKGROUND

Traditional Internet-based search engines search by matching keywords specified by a user in a search specification. These search engines may provide an efficient means for searching the huge number of documents or websites available on the Internet, but may not be suitable for finding local businesses or retail locations by their (potential) customers. For example, a search for “pizza,” “Italian,” and “Rome, Ga.” may locate pizzerias in Rome, Ga., but will likely bring up many other links to web pages regarding Rome, Italy, Italian pizza, Roman-style pizza in Atlanta, Ga., and the like. Similarly, a search for “Deano's Pizza” may or may not locate a Deano's in proximity to the user, but may also return Deano's in N.Y., Chicago, etc.

In addition, depending on keywords provided on listed websites and agreements made with the search engine provider, those links at the top of the search results and/or on the first page of the results may not be of interest to a user who is attempting to search for pizza restaurants nearby. Search engine providers may attempt to target specific results based on the user's search history, location, determined from the user's IP address, for example, and the like. However, depending on the user's searching habits or lack thereof, the search engine may not be able to infer enough information regarding the user in order to provide the user with the results desired, especially when the user is attempting to search locally for specific types of businesses and/or services.

It is with respect to these considerations and others that the disclosure made herein is presented.

### BRIEF DESCRIPTION OF THE DRAWINGS

FIG. 1 is a block diagram showing aspects of an illustrative operating environment and several software components for implementing the embodiments presented herein;

FIGS. 2 and 3 are flow diagrams detailing functions and features performed by logic modules, according to embodiments described herein;

FIGS. 4A and 4B are data model diagrams showing details of a database for storing data utilized by the logic modules in providing local, targeted listings to users, according to one embodiment;

FIG. 5 is a screen diagram showing an example user interface presented by a web server on a client computer, according to embodiments described herein;

FIGS. 6-37 are screen diagrams showing other examples of user interfaces presented by the web server for performing the functions and features described herein, according to embodiments; and

FIG. 38 is a block diagram showing an illustrative computer hardware and software architecture for a computing system capable of implementing aspects of the embodiments presented herein.

### DETAILED DESCRIPTION

The following detailed description is directed to technologies for targeting listings based on user-supplied profile and interest data. Utilizing the technologies provided herein, a local listings provider may provide the ability for an individual or business user to find local businesses and services based on the user's location, demographics, interests, traits, characteristics and other profile information supplied to the website by the user. Similarly, businesses may provide targeted, local listings to potential customers in their area based on the types of people who would likely buy their products and services. Businesses seek to increase their advertising ROI through targeted advertising and consumers, both individual and business, seek relevant product and service information without being inundated by irrelevant advertisements, SPAM, and other intrusive and distracting marketing mechanisms.

While the subject matter described herein is presented in the general context of program modules that execute on one or more computing devices, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced on or in conjunction with other computer system configurations beyond those described below, including multiprocessor systems, microprocessor-based or programmable consumer electronics, minicomputers, mainframe computers, handheld computers, personal digital assistants, cellular telephone devices, electronic-book readers, special-purposed hardware devices, network appliances, and the like. The embodiments described herein may also be practiced in distributed computing environments, where tasks are performed by remote processing devices that are linked through a communications network. In a distributed computing environment, program modules may be located in both local and remote memory storage devices.

In the following detailed description, references are made to the accompanying drawings that form a part hereof, and that show, by way of illustration, specific embodiments or examples. The drawings herein are not drawn to scale. Like numerals represent like elements throughout the several figures.

Most searches performed on the Internet are based on e-commerce. A higher percentage of users are trying to find a product or service versus trying to research “Michelangelo” for a book report. According to embodiments, when a user enters the local listings provider's system, they are instantly shown targeted local business listings generated based on user profile information supplied by the user. There is no requirement to specify a search query, such as “Italian restaurant.” The user profile information may comprise traditional demographic information, such as location, age, gender, marital status, number of children, age range of children, employment status, income range, and the like, as well as trait and characteristic data, such as interests; hobbies; religion; type of employment; personality traits; types of products, services or businesses of interest or desired in the personalized presentation; and the like. The system provides personalized listings that are filtered based on the user-supplied profile information. For example, if a user is a 47 year old male who is married but with no children, that user may not be delivered a listing for Wee Tots clothing stores unless the user specifically asks for “Wee Tots” stores or adds an interest to their profile that would drive relevant targeted listings to his personalized listings, for the reason of purchasing a present for a niece, nephew or baby shower, for example.

To establish a user profile, the user may supply the demographic information and be presented with a list of interests, traits, characteristics, and business types or classifications from which the user may select his or her interests and characteristics to be stored in the user profile. According to one embodiment, the list of interests, traits, and characteristics may be pre-filtered based on already provided profile information. For example, if a user is not married and has no children, then the list of interests, traits, and characteristics may not include “stay-at-home spouse” as type of employment. For example, a user may select interests and traits of “civic-minded,” “leadership-minded,” “health nut,” “green,” “hobby enthusiast,” and the like that may be determinate of the type of products and services that the user might purchase. For example, if the user is “green,” the user may wish to buy organic foods, green cleaning products, and the like. If the user is a “health nut,” the user may shop at health food stores and eat at restaurants that have a healthy theme. If the user selects “book stores” as a business type desired the user will have book stores provided in their personalized listings, less any individual entities or sub-group the user has chosen to exclude or “hide”.

If the user indicates that the he or she is into extreme sports, like skydiving, then certain insurance companies may not provide coverage for that user, and these insurance companies may be excluded from listings of insurance companies provided to the user. If the user indicates traits, such as “civic-minded,” that user may be presented with listings for local civic or service organizations, such as rotary clubs or exchange clubs. The amount of interest, trait, and characteristic information selected by the user may be optional. If the user only provides basic profile information, the user may get all possible listings for his or her location, which may not be helpful. The more information provided by the user, the more personal and more targeted the listings provided will be. According to one embodiment, the user may further be able to specify both inclusionary and exclusionary interests, traits, and characteristics.

Individuals or businesses wishing to place listings in the local listings provider system may also create listing profiles that specify the location or service area of the business, the type of business, the business hours, contact information, such as email address, web address, and phone number, and the like. The business may also select one or more product or services classifications from a list, in a similar fashion to the interests, traits, and characteristics selected by the user. Therefore, listings for the business may appear under multiple classifications. For example, a coffee shop may offer coffees, pastries, and the like. This business may select just a few product or services classifications from the list, and the listings for the business may appear under a few classifications. However, a very large department store, such as a WAL-MART® store from Wal-Mart Stores, Inc. of Bentonville, Ark., may select a large number of product and services classifications from the list, and their listings may appear under most classifications.

The business may also select the demographics, interests, traits, and characteristics of their target customers. This will allow the listings for the business to be targeted towards their likely customers. The customers of a business may include users and/or other businesses. If a business sells to other businesses, the business may further select the types of businesses they sell to. In another embodiment, businesses may create a user profile and may alternatively or additionally select the types of businesses they purchase from. The business may also specify that they are a member of the local Chamber of Commerce and/or the Better Business Bureau. This information may be subject to verification before listings for the business may appear.

A business may further select a membership level or other level of participation for their listing. For example, a basic listing may be provided to all businesses and users who have established a profile. In order to have the listing accentuated, through bolding of the business name, movement to the top of the list in a particular classification, access to additional advertising and communications mechanisms and methods, and the like, the business may pay a particular subscription or other fee. The membership or sponsorship levels may be tiered such that more prominent placement for the listing or other advertising of the business is given to higher levels of membership.

If the business does not specify a website in the profile, the local listings provider system may allow the business to build a basic informational site within the system. This internal website may not be discoverable by search engines on the Internet. However, certain information regarding the business, such as blog entries, customer reviews, and the like, may be exposed or published outside of the local listings provider system such that Internet-based search engines may discover the information. Internet searchers finding the exposed or published information may be directed to join the local listings provider system in order to see the listing, the internal website, and other detailed information regarding the business.

According to one embodiment, a business can specify that customers with certain demographics, interests, traits, and characteristics are their target customers, but are not being reached. The local listings provider may provide services to these customers to help design a campaign that better attracts those types of people. Those services may include designing a blog or running specials, deals, and promotions to generate activity in the target group of customers.

Once a listing for a registered user or business is created, it will show up in the targeted local business listings shown to users based on the location of the user and/or the demographics, interests, traits, and characteristics specified in the user's profile. A user may create multiple profiles, such as one for the user, one for a spouse, one for a child, one as a family, one for a business, and the like. The user may be able to change the active user profile as well as temporarily change an active location for generating the local, targeted listings. For example, the user may wish to see listings that match his or her profile but in another location while on vacation, during a business trip, while around a relocation, or other reason. According to one embodiment, the default profile initially utilized when a user logs into the local listings provider system may be the last profile selected by the user.

The listings may be organized by business-type classification based on the products and services selected by the corresponding businesses in the creation of the business's profile. For example, a coffee shop may offer coffees, pastries, and the like. This business may select just a few business types or product and service classifications from the list of products and services, and the listings for the business may appear under just one or a few classifications. However, a very large department stored, such as a WAL-MART® store, at varying tiers of membership or sponsorship, or for varying additional fees, may select a larger number of business types and product and service classifications from the list, and their listings may appear under most classifications. According to one embodiment, the user may be able to scroll the listings vertically in the screen display, as well as horizontally within a particular listing.

Listings may show the name of the business, a customer rating, a short description of the business, a location of the business, such as an address, contact information for the business, such as a phone number or email address, hours of operation, a website address, and the like. This information may come from the profile for the business. The listings may further show icons indicating if the business is a Chamber member, a member of the Better Business Bureau, offering specials, deals, and promotions, has a blog and/or unread blog entries, an overall customer rating for the business, e.g. a “star rating,” and the like. The user may further be able hide a particular listing such that it doesn't show in that user's listings in the future, claim a listing as their own, or report a listing as misclassified, misleading, inappropriate content, out of business, and the like. Clicking on a listing or an icon in the listing may allow the user to see detailed information for the associated business, including profile information, a longer description of the business, a map of their location, customer reviews regarding the business, specials, deals, and promotions, and the like. The user may also be able to visit the business's internal or external website.

The user may be able to specify that they wish to see all businesses local to their area organized by business type classification. Businesses within a local area may be determined by city, county, zip code(s), a radius about the user's location, or other geographic data method. According to one embodiment, the user may temporarily or permanently change the radius for filtering listings. The user may be able to collapse and expand the various classifications listed to limit the listings shown on the screen. The user may be able to select one or more classifications to further refine the listings shown to the user. The user may also be able to specify that the listings should be filtered by matching the demographics, interests, traits, and characteristics in the user's profile to demographics, interests, traits, and characteristics specified by a business for target customers or observed trends in customers' demographics, interests, traits, and characteristics. The matching may be performed using a number of algorithms known in the art.

The matching may be used to both filter the listings shown to a particular user and sort the listings. In this way, a clothing store specializing in outerwear in the user's area may be shown to a user specifying an interest in outdoor sports and who is a health nut, but may not be as high in the list as a clothing store that has outerwear and workout gear. The user may also be able to specify advanced search queries, such as a keyword or content search, to further limit the listings shown under the selected classifications, or to show additional businesses in the user's local area that were not initially shown because the business profile did not match the interests, traits, and characteristics in a user's profile.

In another embodiment, matching listings may be listed in alphabetical order, by customer rating, by distance from user's location, based on selected favorites, and/or some combination of these and other factors. The user may be able to select the type and order of sort and filtering options, to be utilized such as distance radius combined with best match to interests, traits, etc., in that order. The user may further be able to specify certain interests and/or traits which are most important to be utilized in sorting and/or filtering. For example, if a user's Jewish belief is an overriding trait, then that user may only wish to shop at Jewish friendly businesses and, therefore, have listings from businesses that have specified Jewish trait for their target customers sorted to the top of the list.

The user may further see advertisements based on one or more of the user's location, selected classifications for listings, and search queries specified, as well as the demographics, interests, traits, and characteristics in the user's profile. The placement of the advertisements may be based on the level of participation of the associated business. In addition, the advertisements may be shown based on the level of participation by the associated business despite filtering and/or sorting applied to the listings by the user. Clicking on an advertisement may allow the user to see the business's internal or external website.

Advertisements may be selected to be shown to users based on specified zip code(s) selected by the business or based on users located within a certain radius about the business location. The radius may be specified in miles, or it may be specified by a particular number of people located within the radius about the businesses location. Distances may be calculated based on zip codes, street addresses, or any other method known in the art. In a further embodiment, an impressions-based cost structure, population based cost structure, distance based cost structure, or a pay-per-click cost structure for placing an ad for a business may be tiered based on responses from increasing concentric radii around the business or intersecting radii from advertising targeted geographic areas. Ads may be alternated at the various ad placement locations based on ad rotation methods known in the art.

According to further embodiments, the user may also see and/or subscribe to special, deals, promotions, and events targeted to the user through the demographics, interests, traits, and characteristics in a user's profile. The user may also see or subscribe to blog entries and other crowd-source information similarly targeted to the user through the demographics, interests, traits, and characteristics specified by the user in the user's profile. The user may also see local news, weather, a local calendar of events, comics, and other external information based on the user's demographics, interests, traits, and characteristics. The local listings provider system may receive news, weather, and other external information from external content providers and filter the external information to localize it for the user as well as filter and/or sort the information based on the user's profile. The user may be able to specify the filtering method to be used for the external content, e.g. show all local news or only show news matching the user's specified interests and traits. The local listings provider system may provide a profile classification module to outside providers of news, weather, calendars, comics and other external content for use by the system in correlating to users of the system.

The user may further be able to see other local information based on their location and/or demographics, interests, traits, and characteristics. For example, the user may be able to see, local hospital wait times, local school closings and openings, local business closings and openings, and the like. This information may be sorted and filtered in a similar fashion as to listings described above. In addition, the user may be able to subscribe to this information through RSS feeds, FACEBOOK, TWITTER, IM, text messaging, email, etc.

The local listings provider's system collects and stores metrics, user and business demographics, characteristics, preferences, interaction and the like and may correlate these to provide conventional and unconventional valuable aggregate data and information to advertisers and listed entities related to their customers and potential customers and to users related to users with similar and contrasting data.

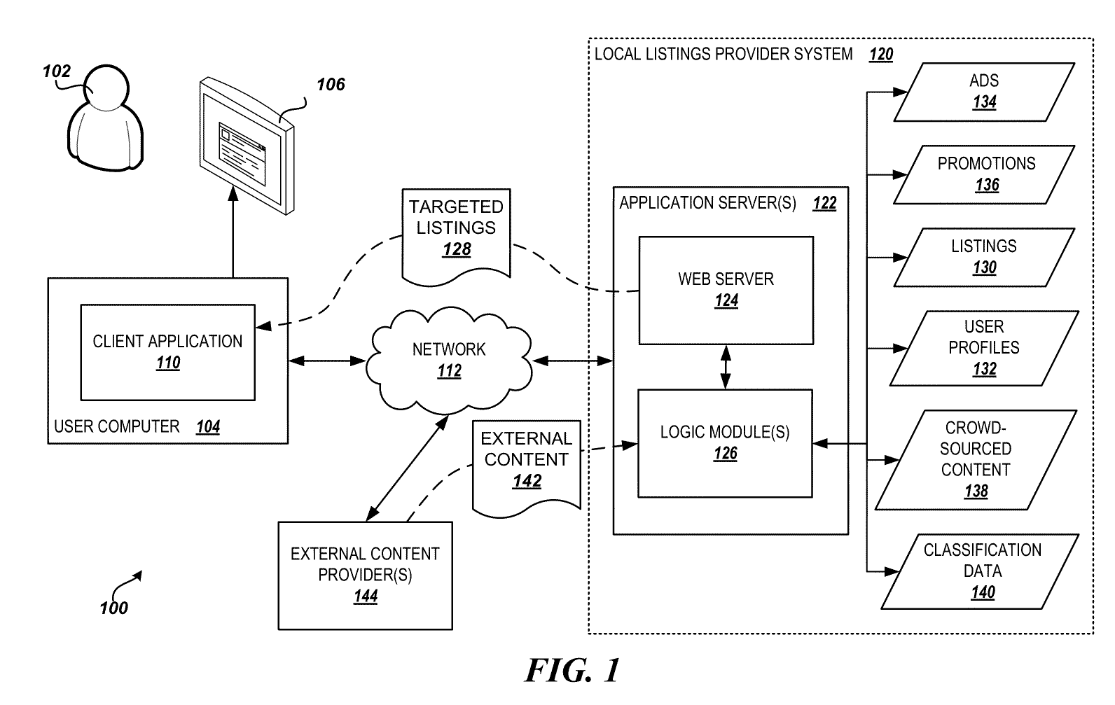

FIG. 1 and the following description are intended to provide a brief, general description of a suitable computing environment in which the embodiments described above may be implemented. In particular, FIG. 1 is a system and network diagram that shows an illustrative operating environment 100 including several software components for targeting listings based on user-supplied profile and interest data, according to embodiments provided herein. The environment 100 includes a user 102 that uses a user computer 104 to access a local listings provider system 120 implemented by the local listings provider across a network 112. The user 102 may be an individual or entity that desires to locate local retail stores, restaurants, hospitals, theaters, parks, fairs, plays, and other businesses, services, events, and the like listed by the listings services provider. The user computer 104 may be a personal computer (“PC”), a desktop workstation, a laptop, a notebook, a personal digital assistant (“PDA”), a smart phone or cellphone, an electronic-book reader, a game console, a set-top box, a consumer electronics device, a server computer, or any other computing device capable of connecting to the network 112 and communicating with the local listings provider system 120.

The network 112 may be a local-area network (“LAN”), a wide-area network (“WAN”), the Internet, or any other networking topology or combination of networking topologies known in the art that connects the user computer 104 to the local listings provider system 120. The local listings provider system 120 may include a number of application servers 122 that provide various listing services to the user computer 104 over the network 112. The user 102 may use a client application 110 executing on the user computer 104 to access and utilize the listing services provided by the application servers 122. According to one embodiment, the client application 110 may be a web browser application, such as the MOZILLA® FIREFOX® web browser from Mozilla Foundation of Mountain View, Calif. The web browser application exchanges data with a web server 124 executing on the application servers 122 or other computing resources in the local listings provider system 120 using the hypertext transfer protocol (“HTTP”) over the network 112. Alternatively, the client application 110 may utilize any number of communication methods known in the art to communicate with the local listings provider system 120 and/or the application servers 122 across the network 112, including remote procedure calls, SOAP-based web services, remote file access, proprietary client-server architectures, and the like.

The application servers 122 may execute a number of logic modules 126 in order to provide the listing services to the client application 110. The logic modules 126 may execute on a single application server 122 or in parallel across multiple application servers in the local listings provider system 120. In addition, each logic module 126 may consist of a number of subcomponents executing on different application servers 122 or other computing devices in the local listings provider system 120. The modules may be implemented as software, hardware, or any combination of the two.

According to one embodiment, one or more logic modules 126 provide targeted listings 128 to the user 102 based on user-supplied profile data, as is described in detail above. The logic modules 126 may generate the targeted listings 128 based on various data available to the application servers 122 in the local listings provider system. For example, the logic modules 126 may match listings 130 to user profiles 132 utilizing the methods and/or algorithms described herein to generate the targeted listings. The listings 130 and user profiles 132 may be stored in a database or other data storage mechanism in the local listings provider system 120 and accessible by the application servers 122. In another embodiment, the listings 130 data may be accessed dynamically from other third-party servers over the Internet or some other network in a near real-time basis.

Similarly, the logic modules 126 may utilize ads 134, promotions 136, crowd-sourced content 138, classification data 140, and/or other data and information in providing content to the user 102 in or in conjunction with the targeted listings, as is further described below. The ads 134 may comprise specific advertisements provided by businesses that are to be displayed to the user 102 in conjunction with the targeted listings 128. Promotions 136 may comprise coupons, deals, special events, and the like that are offered to the user 102 in conjunction with providing targeted listings 128, as described herein. The crowd-sourced content 138 may comprise customer reviews, comments, star ratings, blog entries, and other crowd-sourced data known in the art for enhancing the listings provided by the local listings provider system 120. The classification data 140 may provide profile classes, interests, business types, and other classification data utilized by the logic modules 126 executed on the application servers 122.

The targeted listings 128 and other information generated by the logic modules 126 may be transmitted by the web server 124 over the network 112 to the client application 110 for display to the user 102. The targeted listings 128 may be a web page consisting of hypertext markup language (“HTML”), extensible markup language (“XML”), and/or JavaScript object notation (“JSON”) that contains the listings and other information along with instructions regarding how the targeted listings are to be rendered by the client application 110, for example. The client application 110 may receive the targeted listings 128 and other information from the web server 124 and display the information to the user on a display 106 connected to the user computer 104. In addition, the client application 110 may allow the user 102 to provide user input and interact with the display of information using a number of input devices connected to the user computer 104. It will be appreciated that any number of methods and technologies may be utilized that allow the web server 124 to encode the targeted listings 128 and other information and send the information to the client application 110 for display to the user 102, and it is intended that all such methods and technologies be included within the scope of this application.

According to a further embodiment, the logic modules 126 may retrieve external content 142, such as news, weather, and the like, from external content provider(s) 144. It will be appreciated that such content could be provided internally from contributors through the listings provider system 120. The external content 142 may then be localized and filtered based on interests, location, and other data specified in user profiles 132, and provided to the user 102 by the web server 124 along with the targeted listings 128 and other information.

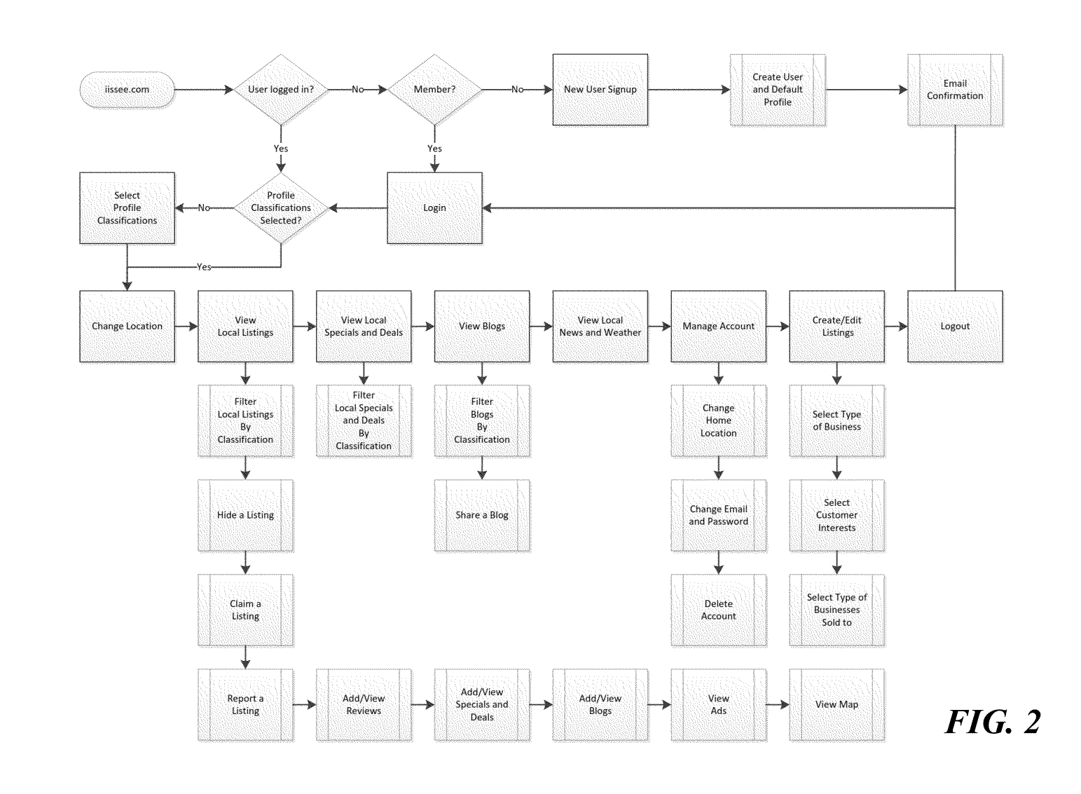

FIG. 2 provides a logic flow detailing the functions and features performed by the logic modules 126 described above to provide the listings services to the user 102. These functions include logging into the local listings provider system 120, creating one or more user profiles 132, specifying a default profile, selecting an active profile classification and/or location, viewing locally targeted listings 128, viewing applicable specials, deals, and other promotions 136, viewing blogs and other crowd-sourced content 138, viewing local news, weather, and other external content 142, managing user and business accounts, creating and editing listings 130, and the like.

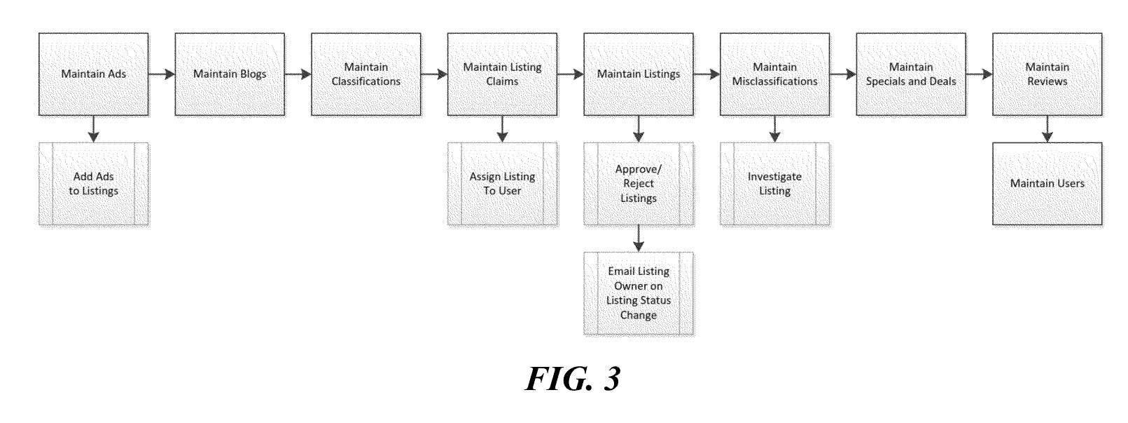

Similarly, FIG. 3 provides a logic flow detailing the functions and features performed by the logic modules 126 described above to allow administration of the local listings provider system 120. These functions include maintaining ads 134, maintaining blogs customer reviews, and other crowd-sourced content 138. Maintaining classification data 140, maintaining listings 130 and listings claims, maintaining misclassifications, maintaining specials, deals, and other promotions 136, and the like.

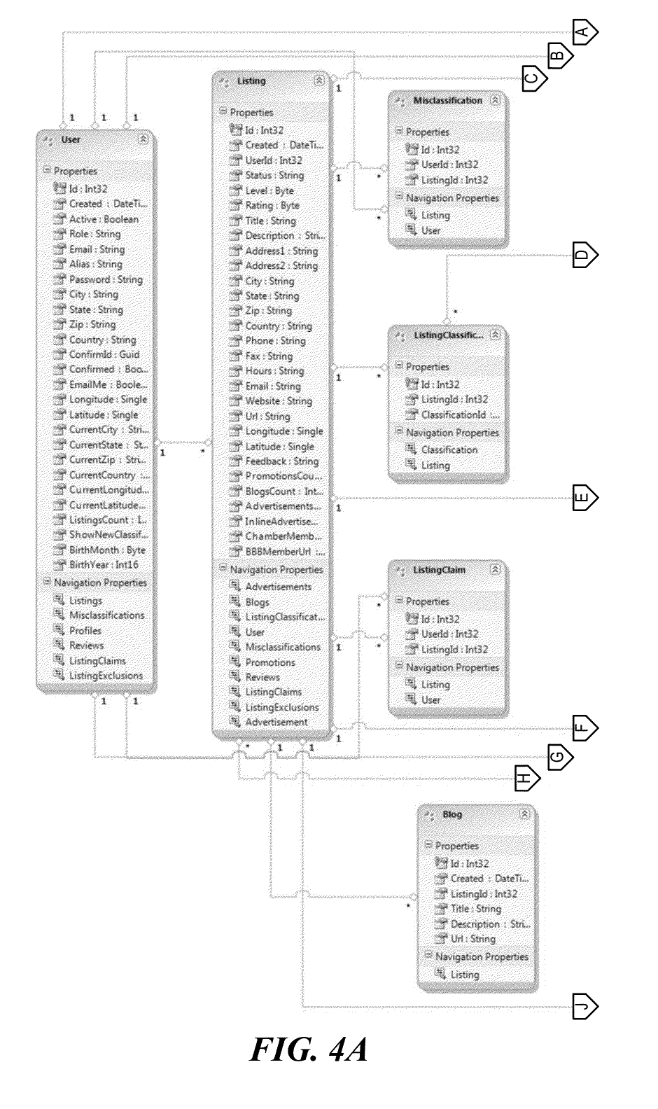

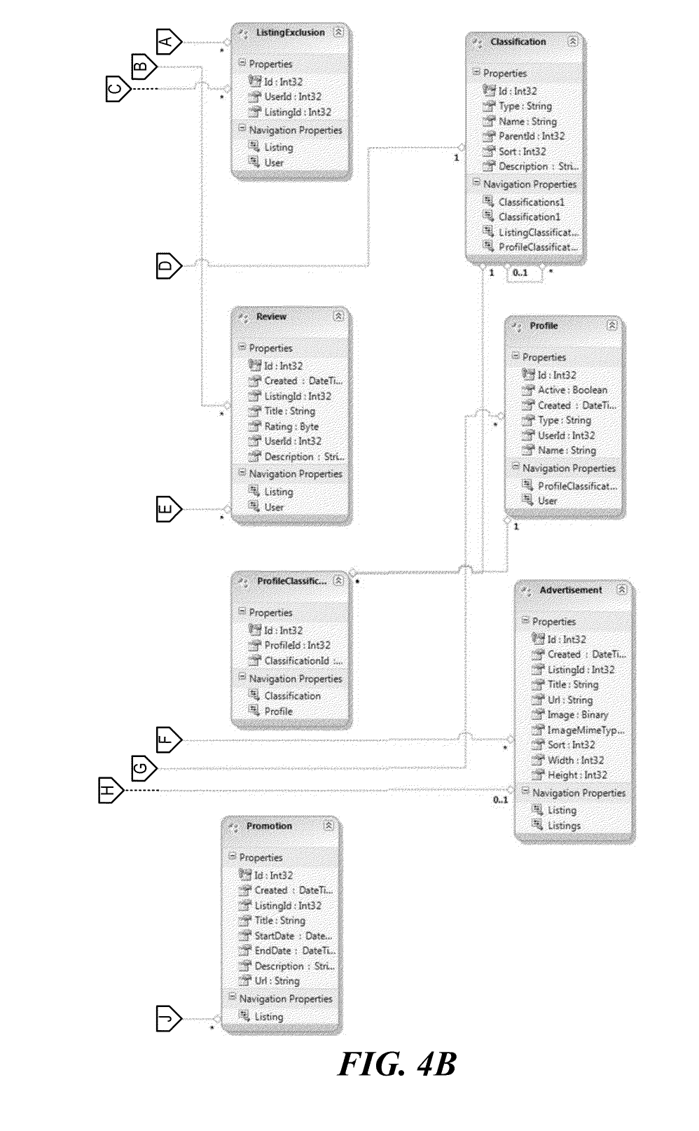

FIGS. 4A and 4B show a data model diagram for a database for storing the data utilized by the logic modules 126 in providing the listing services to the users 102, according to one embodiment. As may be seen in the diagram, the data model includes tables or other objects for the storage of users, user profiles 132, listings 130, ads 134, promotions 136, crowd-sourced content 138, such as blogs and customer reviews, classification data 140, and the like. The data model diagram further shows a number of columns or attributes for each table or object in the database as well as relationships defined between the tables or objects.

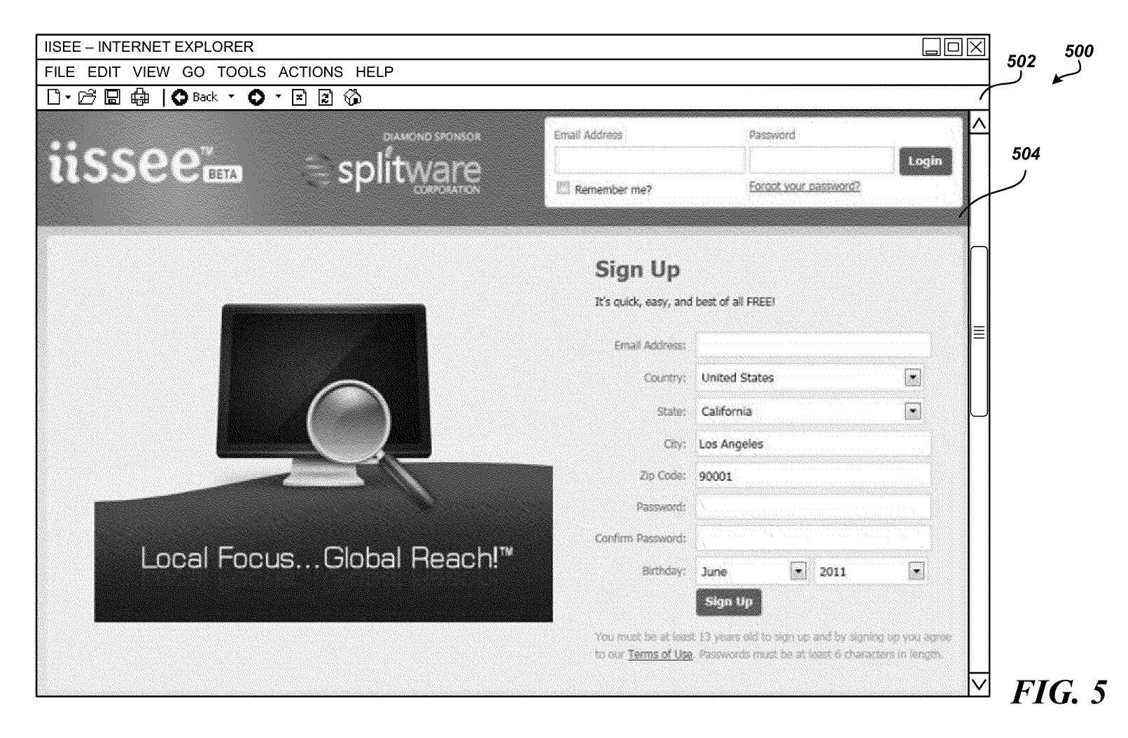

FIG. 5 shows a screen display 500 including a window 502 presented by the client application 110 on the display 106 of the user computer 104, according to one embodiment. The client application 110 may render a user interface 504 in the window 502 based on the HTML, XML, JSON, and/or other data and instructions transmitted by the web server 124 to the user computer 104 over the network. According to embodiments, the user 102 may access and utilize the functions and features described above in regard to FIGS. 2 and 3 and provided by the logic modules 126 through the user interface 504 rendered by the client application. For example, as shown in FIG. 5, the user 102 may initially sign-up for the listings services provided by the local listings provider system 120 by providing basic profile information, such as an email address, a location, a birth month and birth year (for age verification purposes), a password to protect the user's personally identifiable information, and the like. In one embodiment, the country, city, state, and/or zip code may be provided for the user 102 upon initial sign-up based on the IP address of the user computer 104 accessing the web server 124 over the network 112.

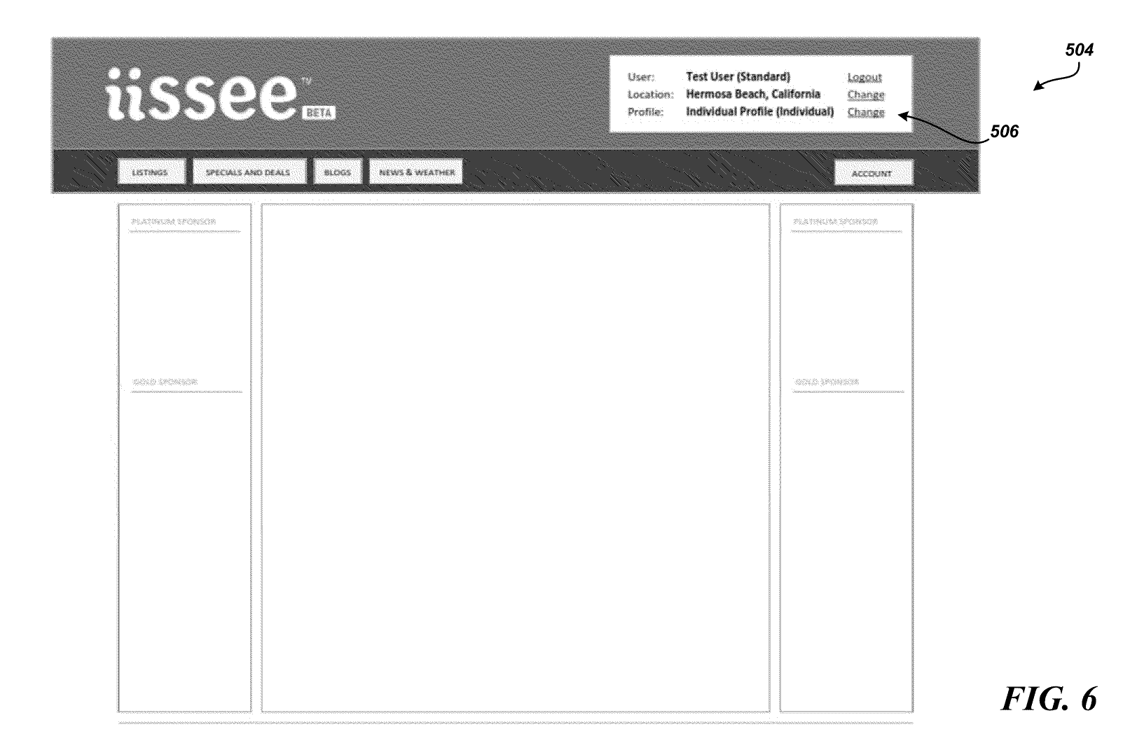

FIG. 6 provides another example of the user interface 504 provided by the web server 124, according to embodiments. In one embodiment, when a user 102 logs into the local listings provider system 120, the user is presented with local listings based on a default user profile 132 set by the user, as shown at 506 in FIG. 6. A user may have multiple user profiles 132, such as one for the user, one for a spouse, one for a child, one for a business, and the like. Because businesses also make purchases from other local businesses and services, the local listings provider system 120 may provide B2B listing services, as well.

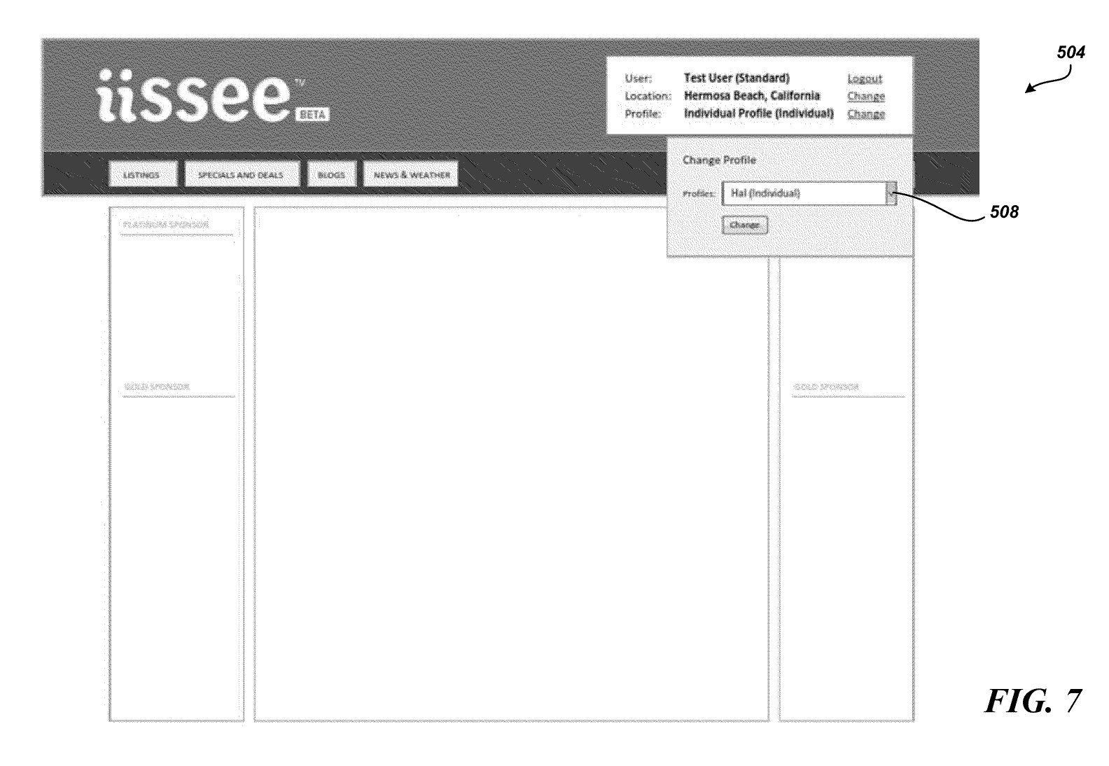

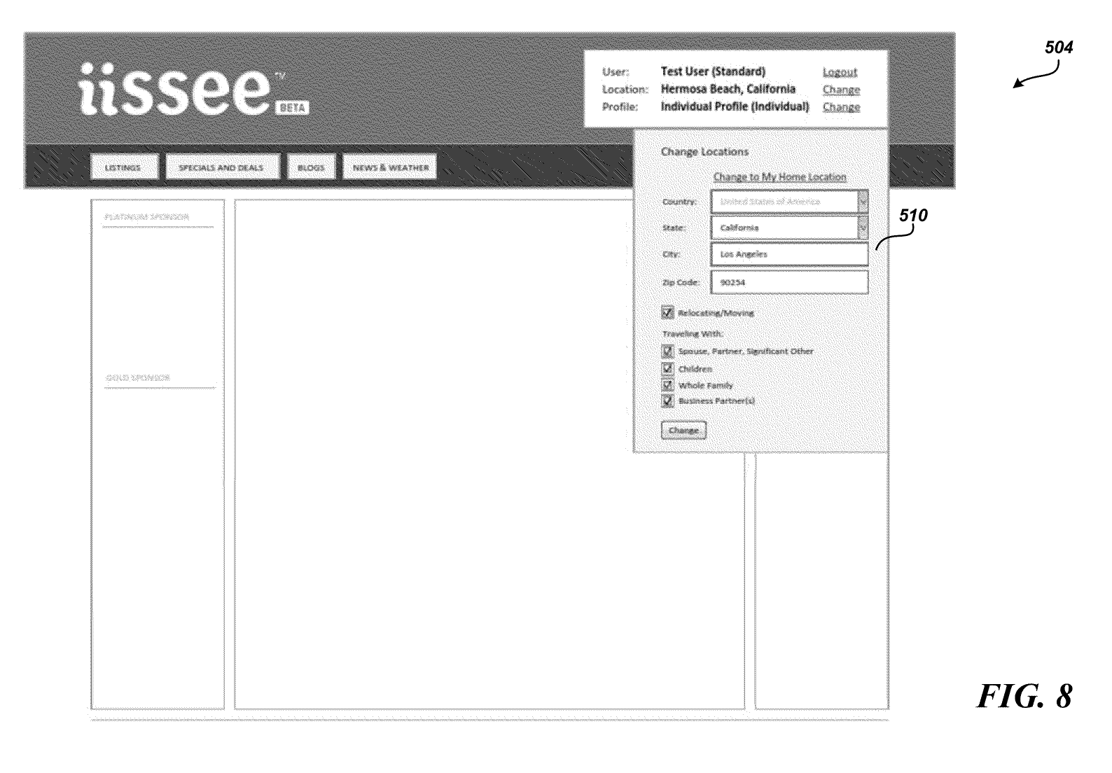

The user 102 may be able to change the active user profile 132, as shown at 508 in FIG. 7. The user 102 may also be able to change an active location for generating the local, targeted listings 128. For example, the user 102 may wish to temporarily change their location from that defined for their profile for searching for local listings while on a business trip or planning a vacation. As shown at 510 in FIG. 8, the user 102 may be able to select whether they are relocating, moving or traveling with their spouse, partner, children, or whole family, on a business trip, and the like. Depending on the user's selection, the targeted listings 128 presented to the user 102 may be adjusted. According to one embodiment, the last selected profile may serve as the default profile and location for the user 102 the next time the user logs into the local listings provider system 120.

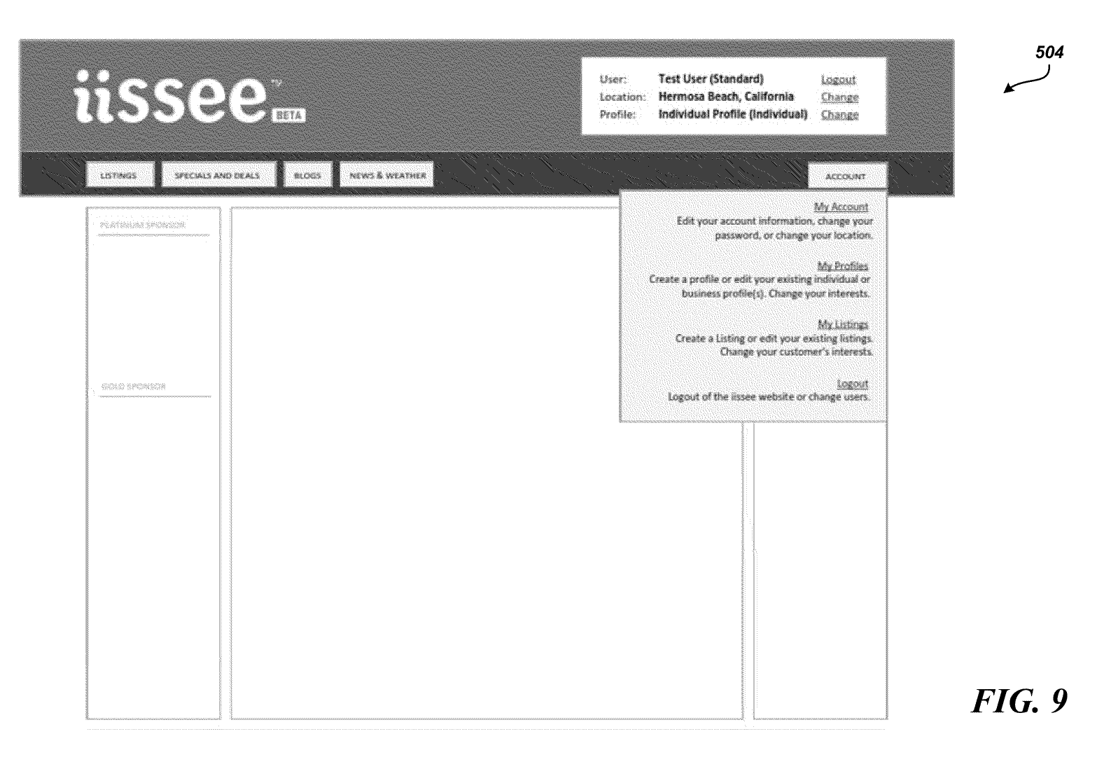

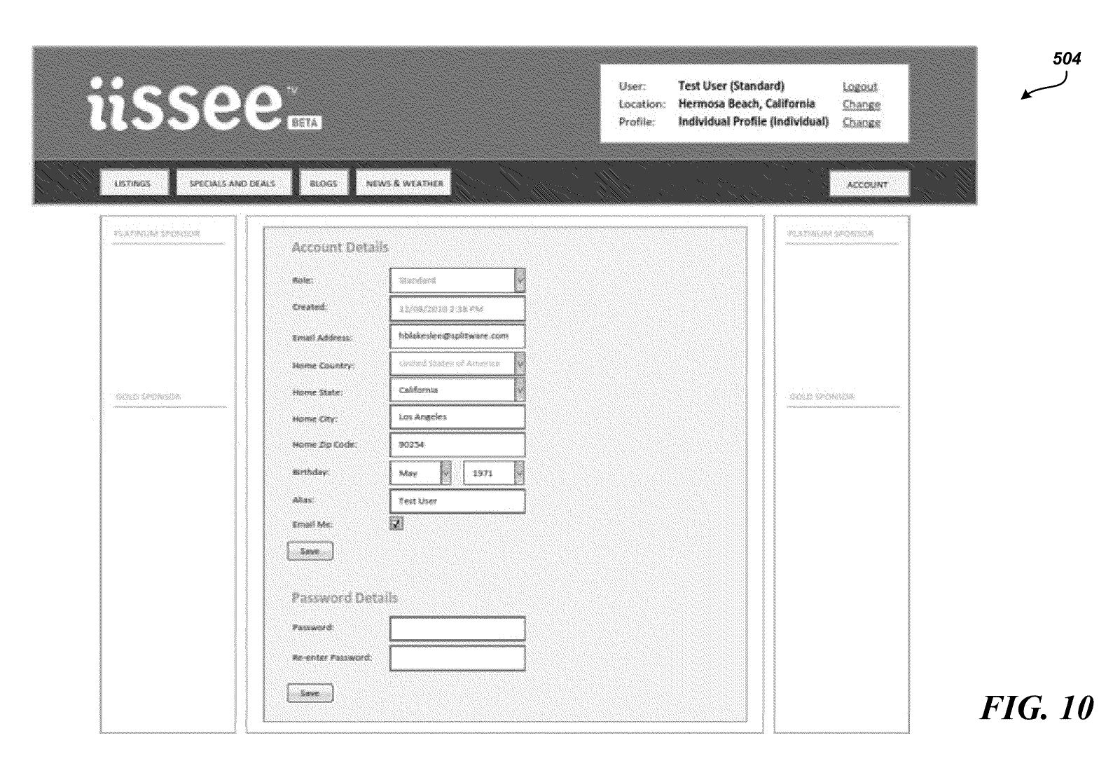

FIG. 9 provides another example of the user interface 504 provided by the web server 124, according to embodiments. In one embodiment, the user 102 is provided with menu selections to initiate functions for modifying the user's account settings, the user's profile(s), the user's listings, and the like. FIG. 10 shows a sample of account details that may be modified by the user 102.

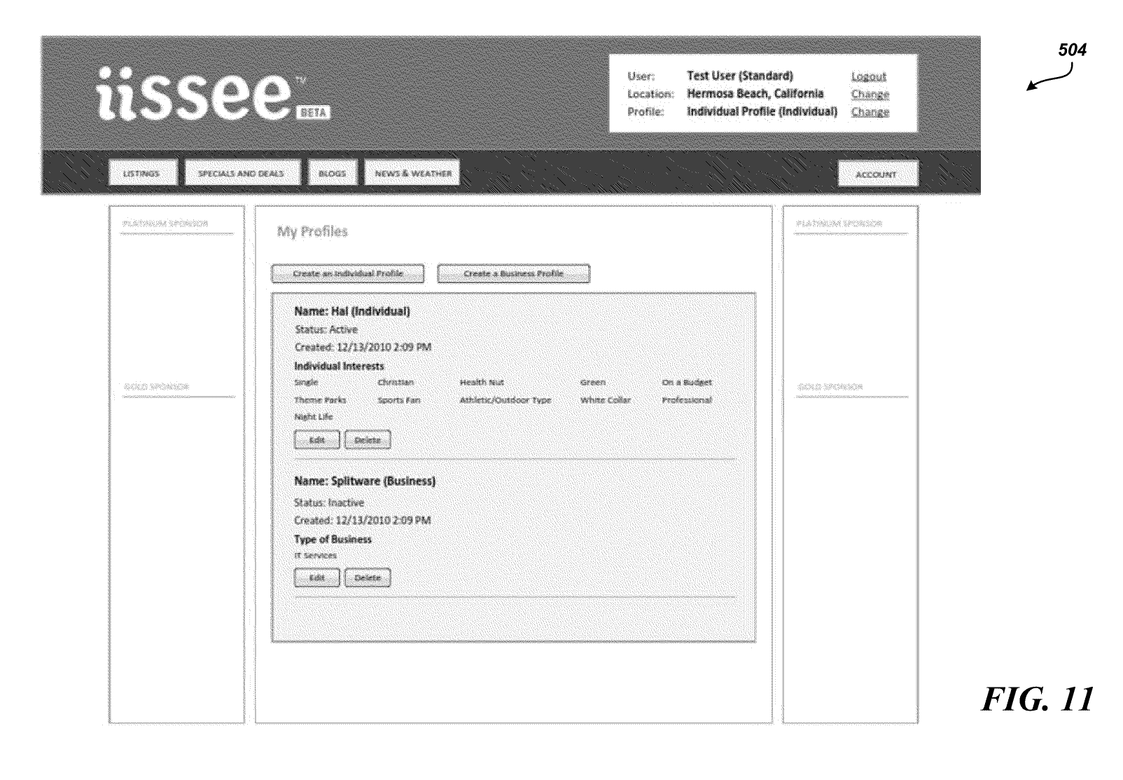

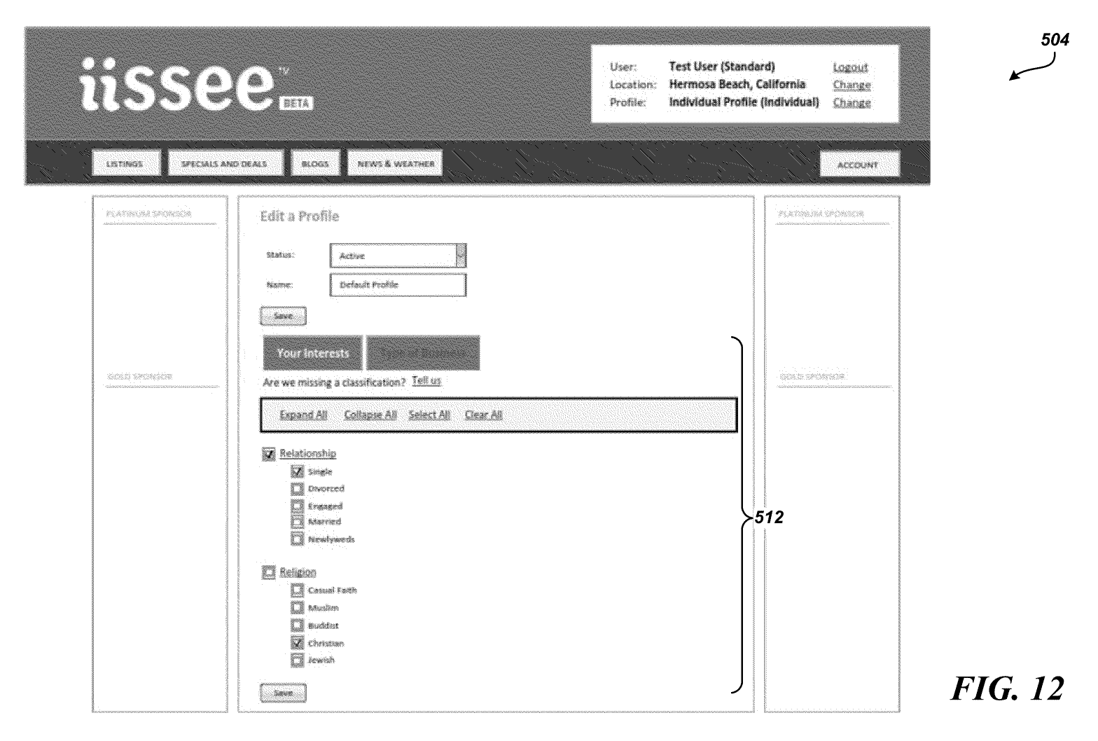

FIG. 11 shows a user interface 504 for selecting from among and editing the user's various user profiles created by the user 102. FIG. 12 shows an example of a list of various user profile and interest data that may be provided by the user 102 in creating/editing a user profile by selecting from a list demographics, interests, traits, and characteristics, as shown at 512.

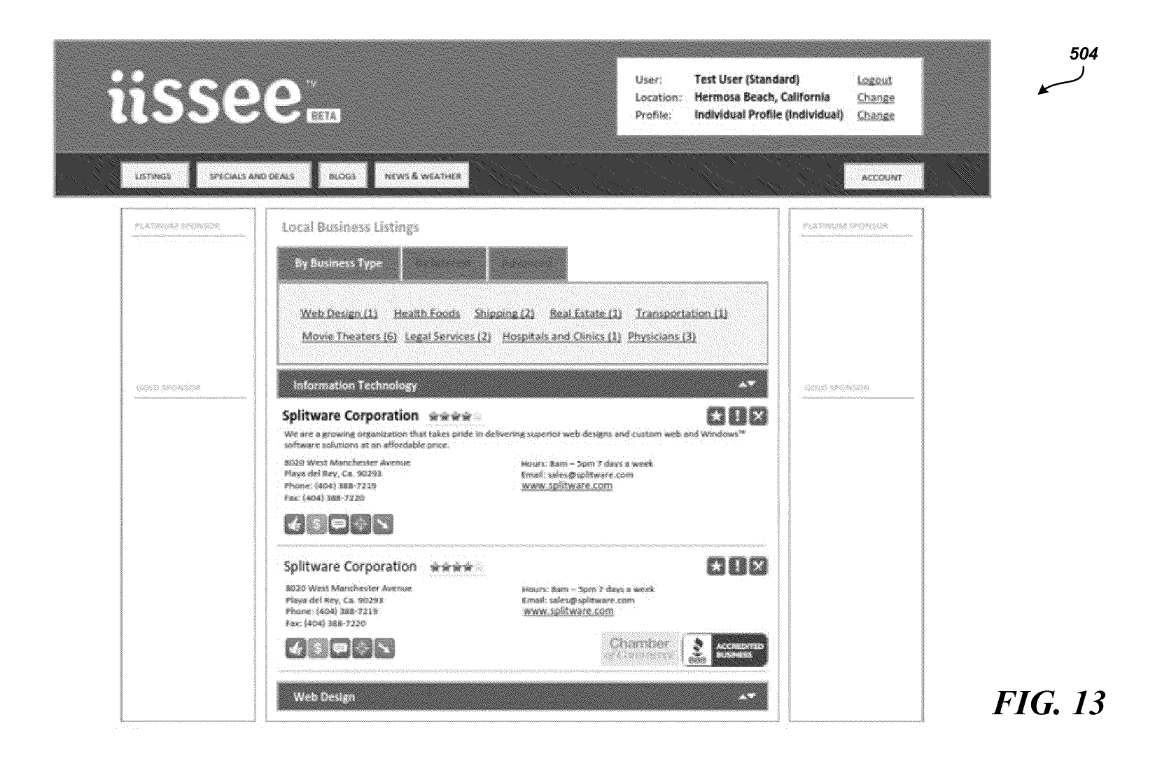

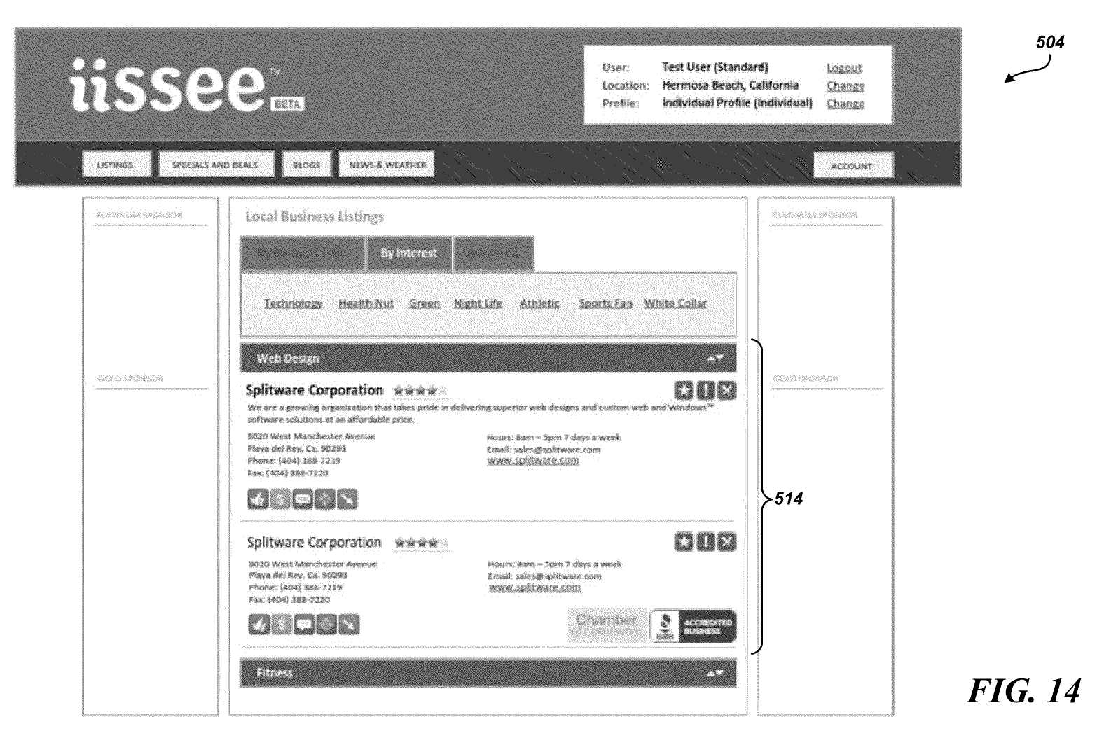

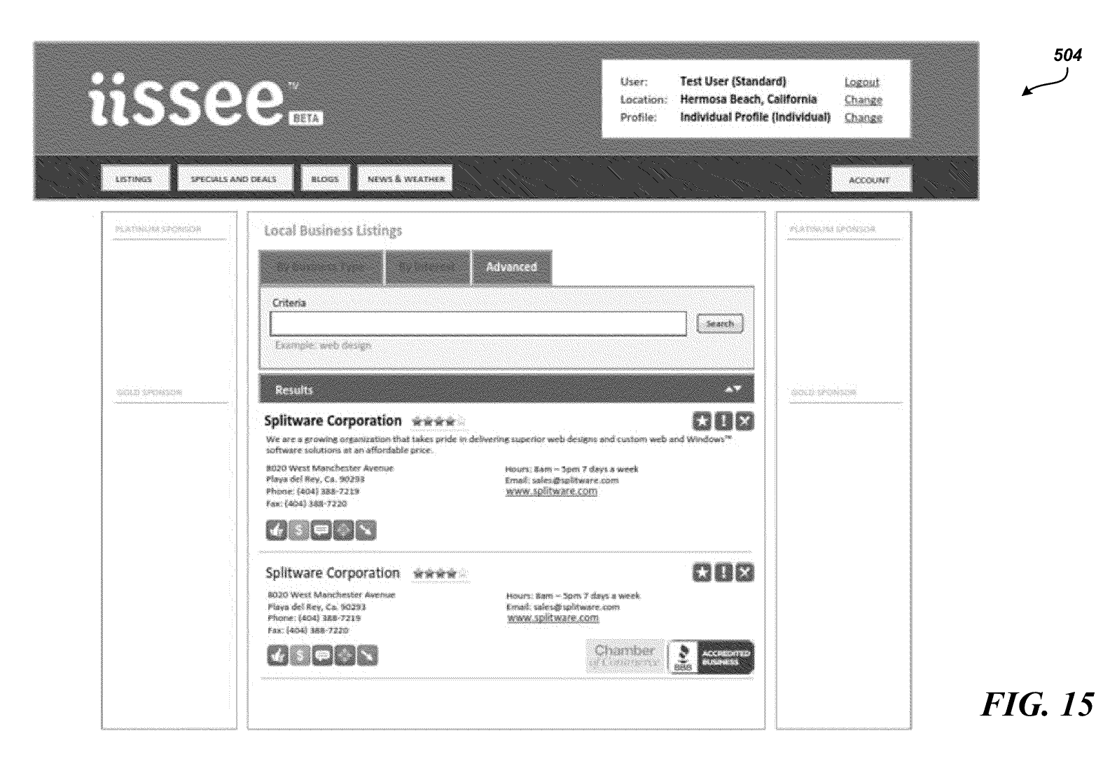

FIGS. 13 and 14 show examples of targeted listings 128 shown to a user 102. As shown at 514 in FIG. 14, targeted listings 128 may be displayed to the user 102 on the user interface 504. The targeted listings 128 are organized by business-type classification and show information regarding the associated businesses as described above. As shown in the figures, the user 102 may see local listings by business type or local listings for businesses that match the user's profile and interest data, including interests, traits, and characteristics specified in the user's profile. The user 102 may further be given user interface controls that allow the lists to be filtered by one or more business-type classifications and/or interests, traits and characteristics, as further shown in these figures. The user 102 may also be able to supply a search query to search for local businesses by keyword, for example, as shown in FIG. 15.

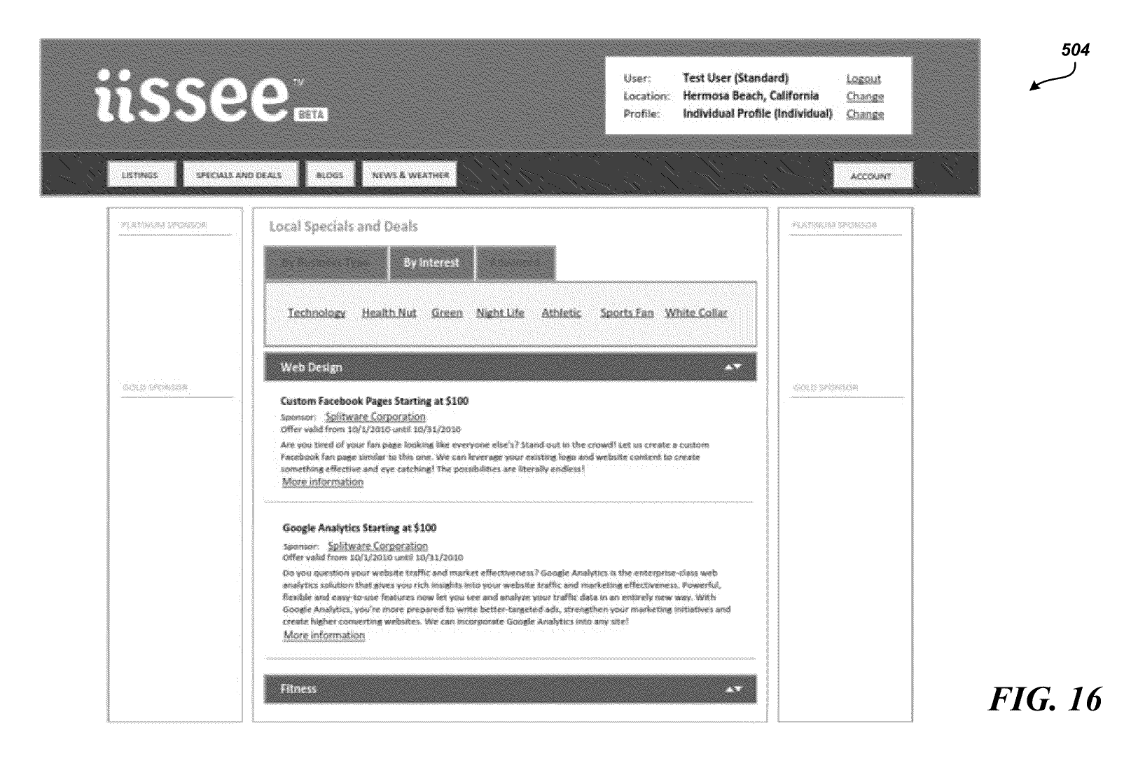

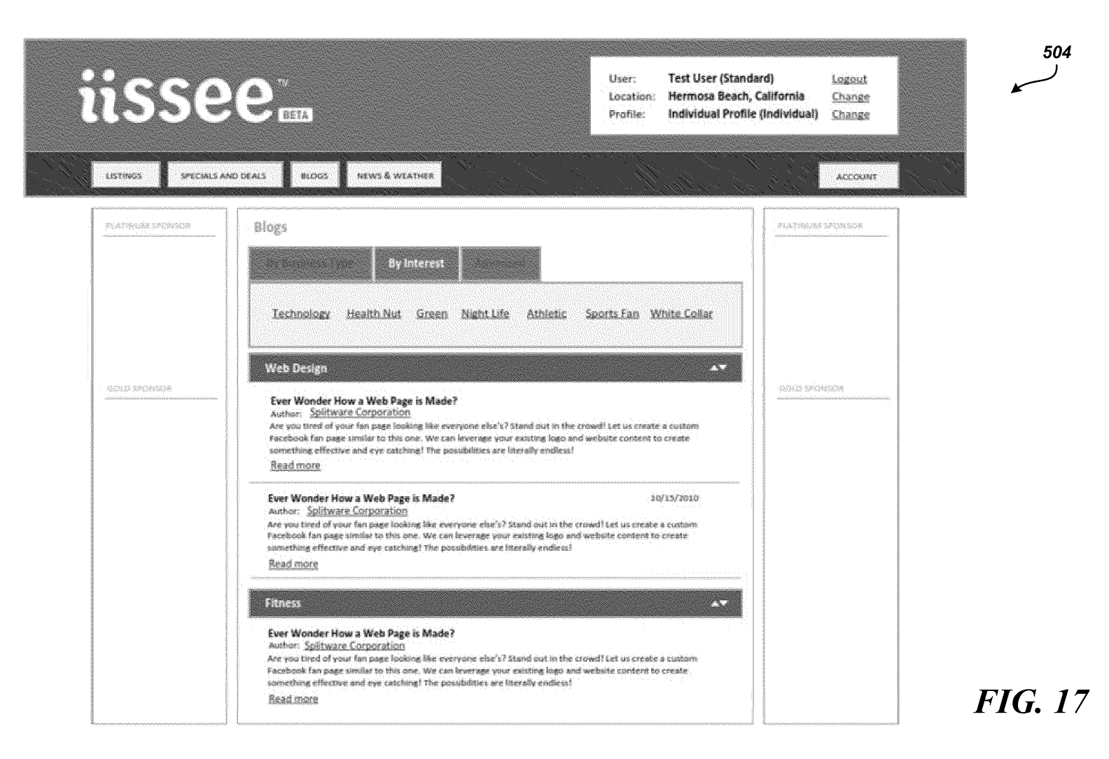

In addition to the targeted listings 128, the user 102 may be able to view specials, deals, and promotions sorted and/or filtered by business-type classification and/or interests, traits, and characteristics, in a manner similar to described above, as shown in FIGS. 16 and 17.

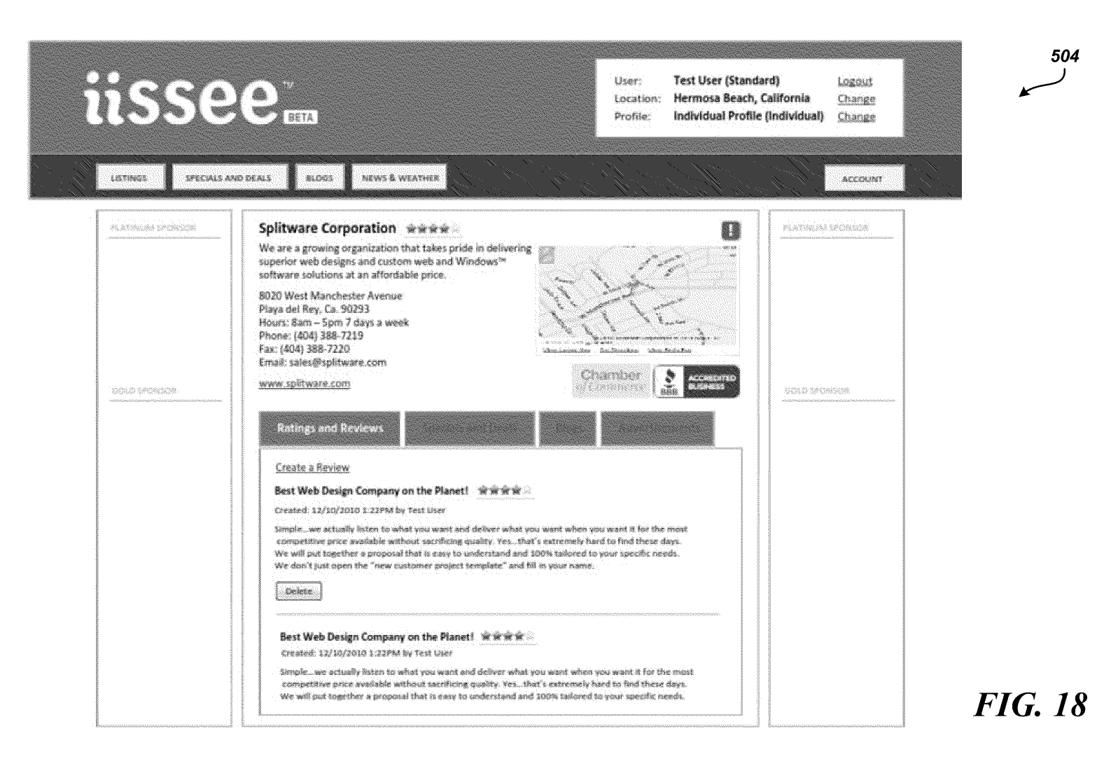

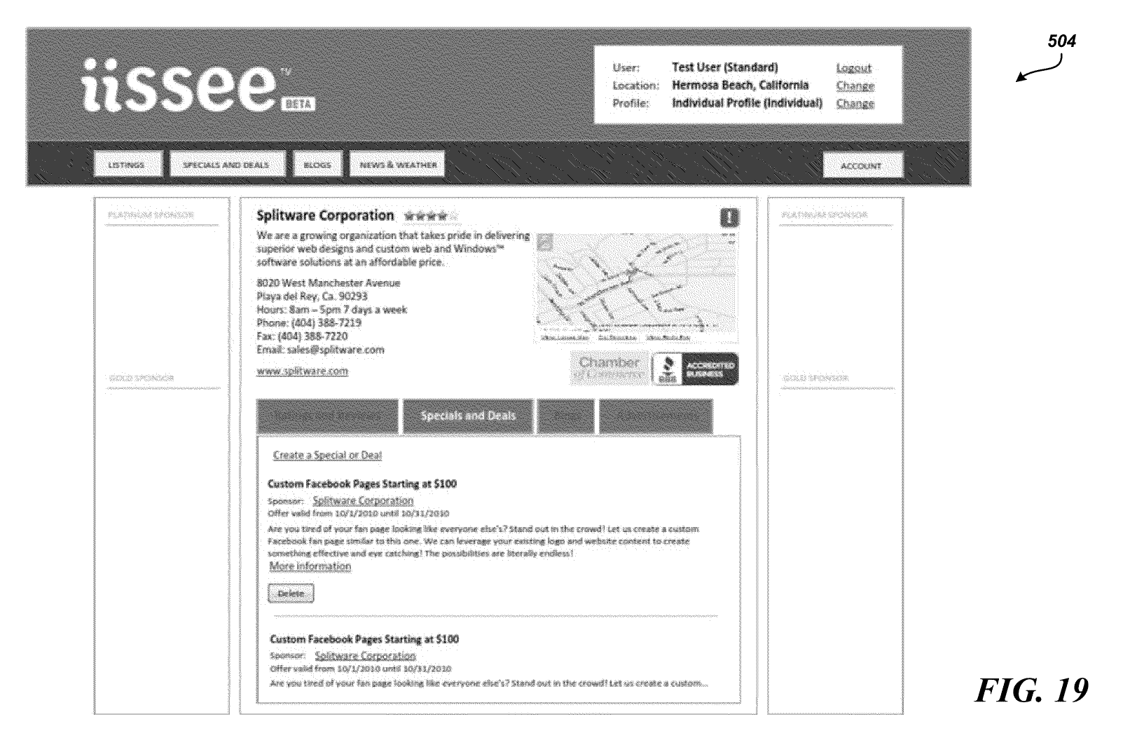

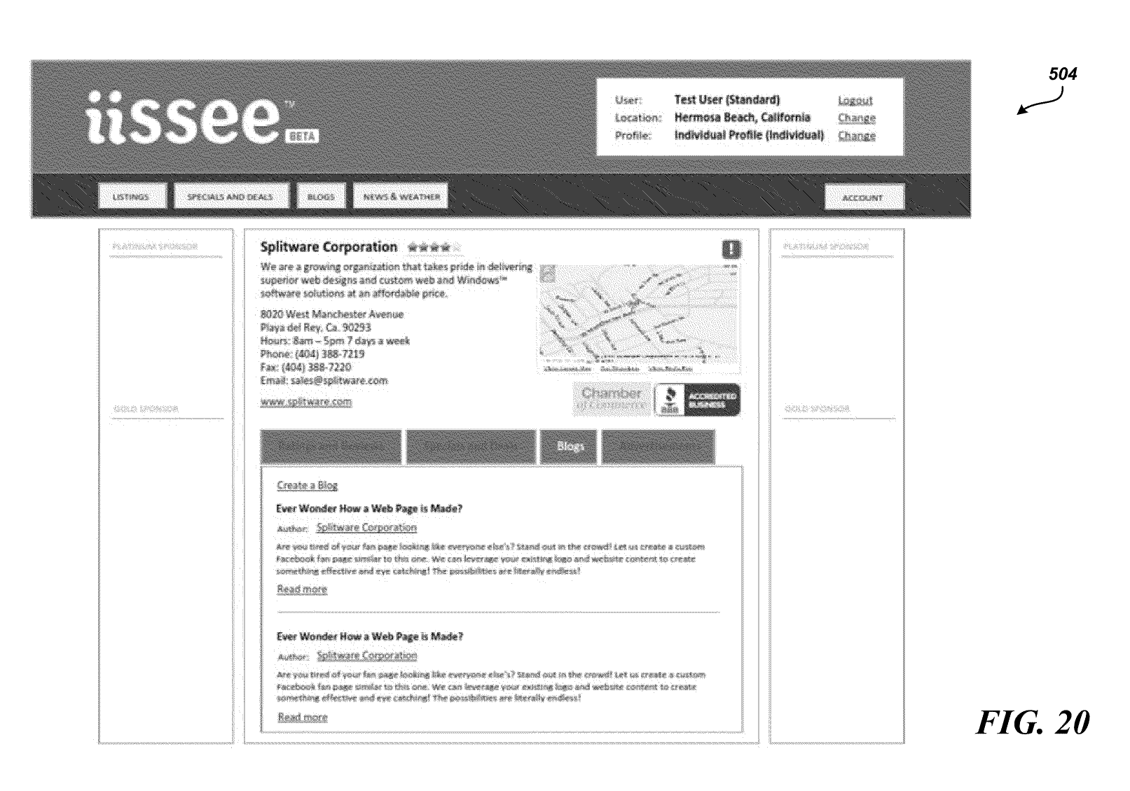

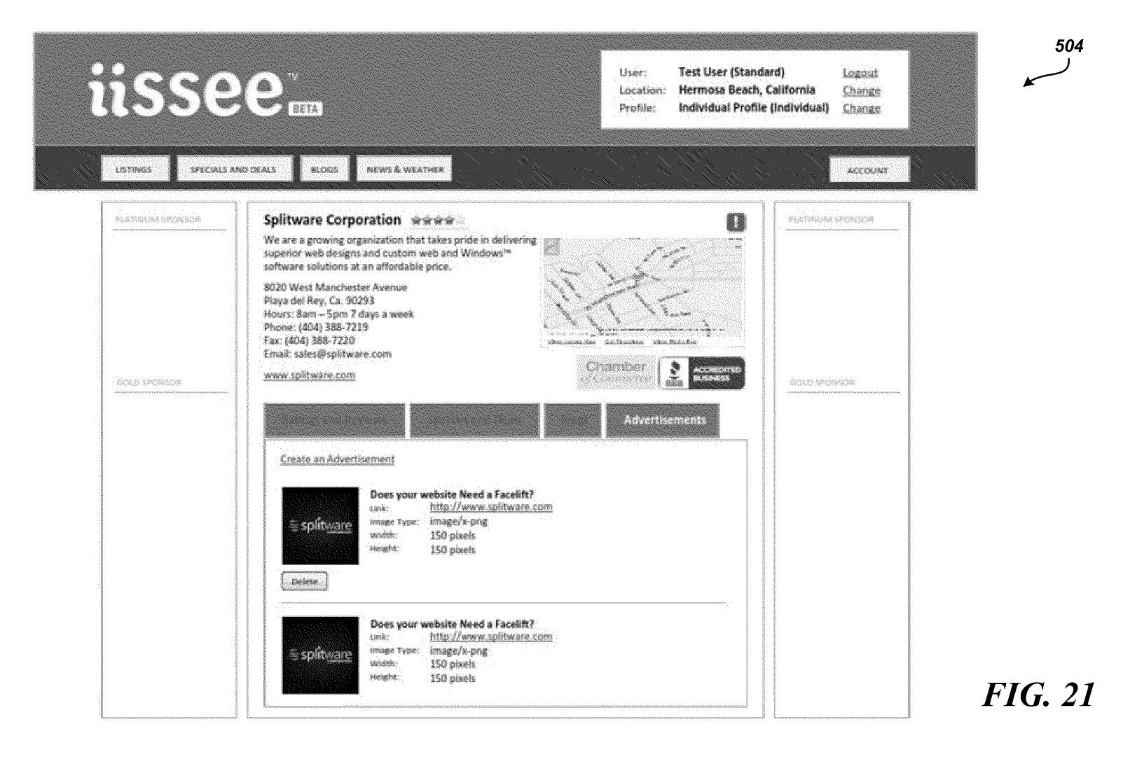

FIGS. 18-21 show example user interfaces 504 containing details regarding a business listed in the local listings provider system 120. The user 102 may be shown information provided in the figure upon clicking a listing in the targeted listings 128 or an advertisement displayed to the user. The details regarding a business listing may include the name of the business, a description of the business, the business's location and/or operating hours, contact information for the business, a website address for the business, a map of the business location, customer reviews and ratings for the business, specials, deals, and promotions offered by the business, blog entries provided by the business, advertisements for the business, and the like.

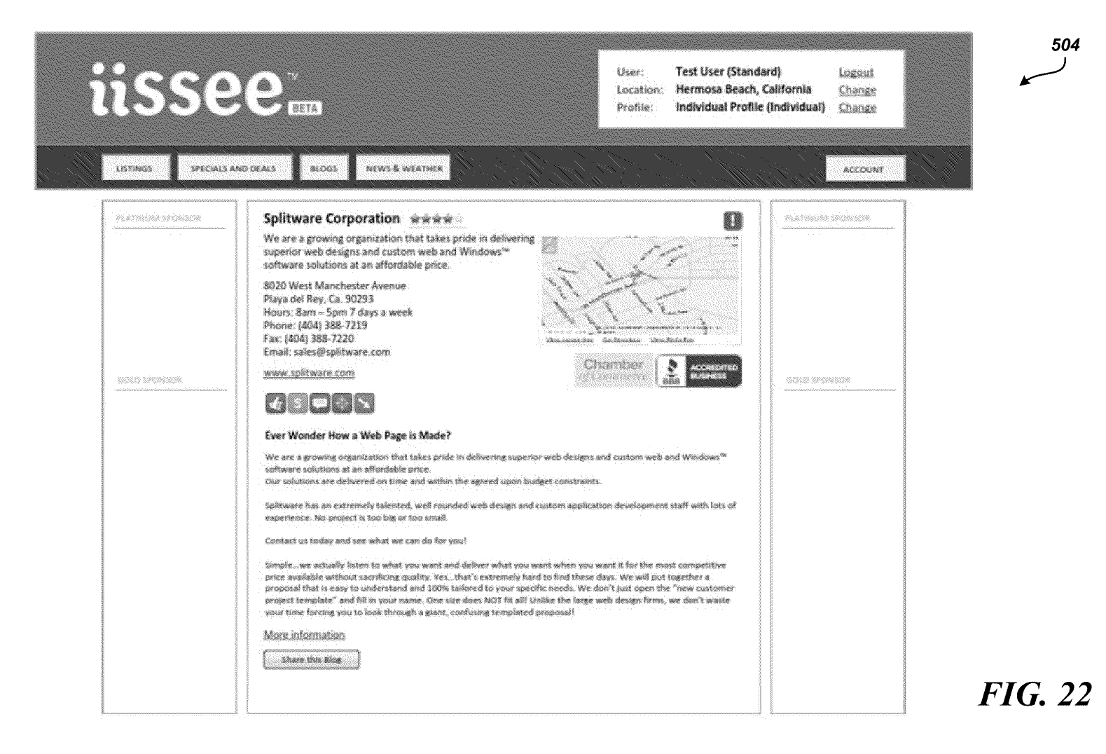

FIG. 22 shows an example user interface 504 for displaying a blog entry for a business.

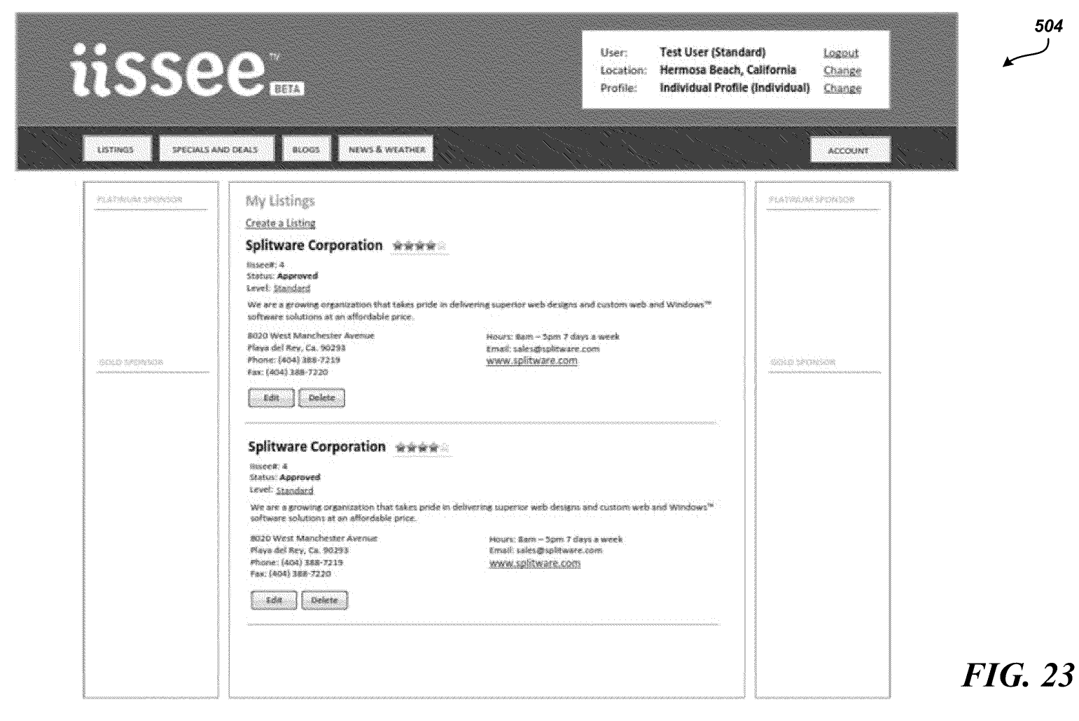

FIG. 23 shows an example user interface 504 for creating, editing, and deleting listings for a user or business.

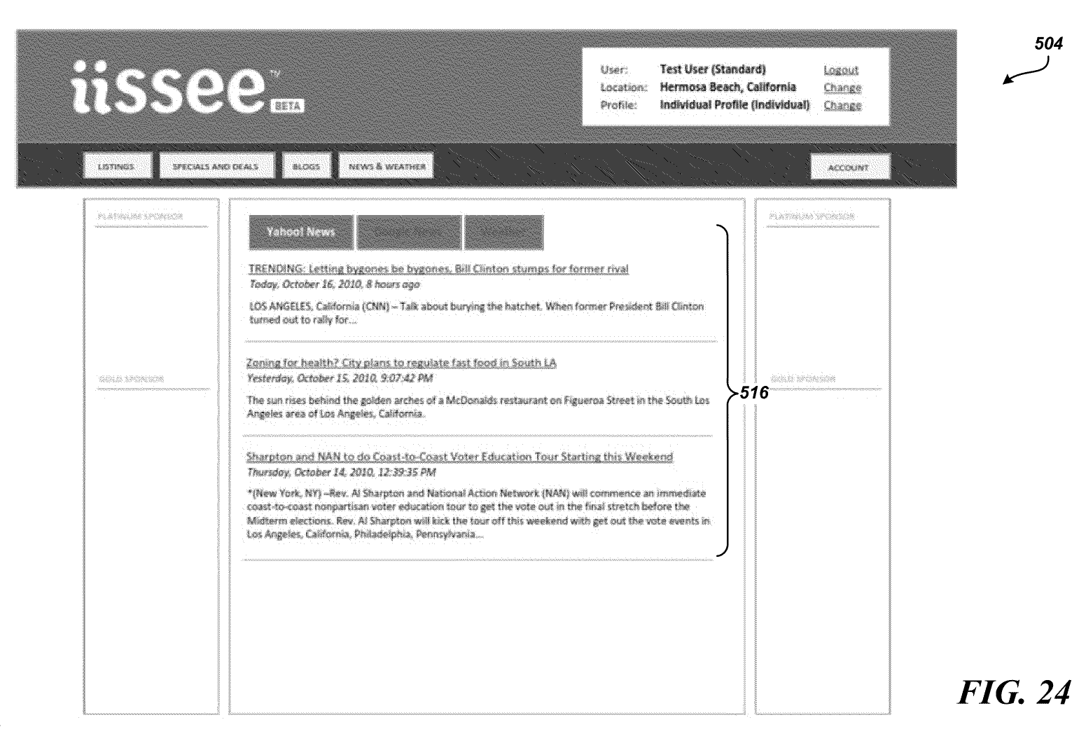

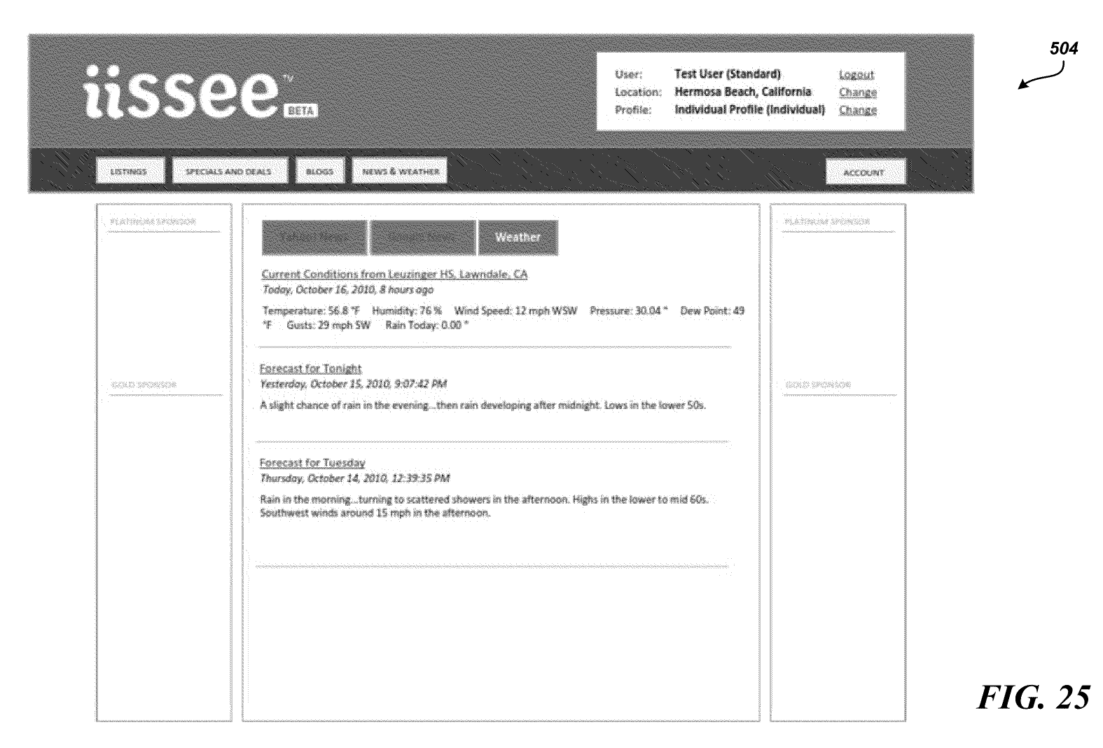

FIGS. 24 and 25 show example user interfaces 504 for displaying localized external content 516 to a user 102.

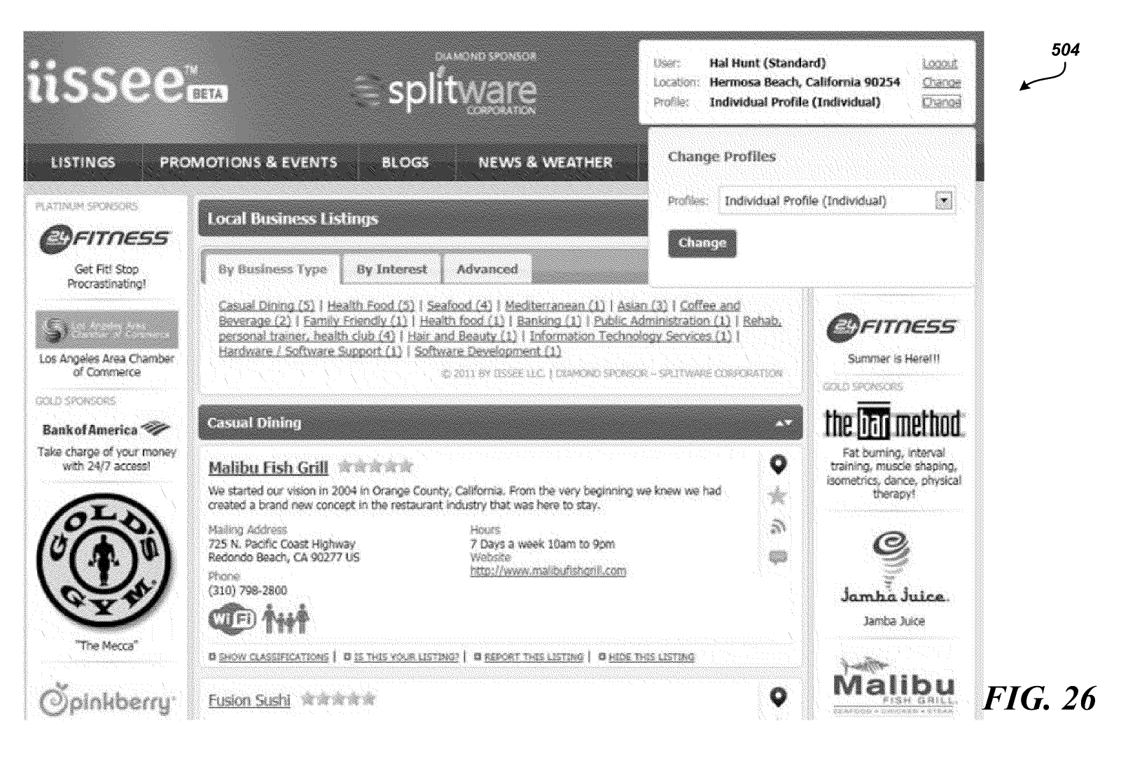

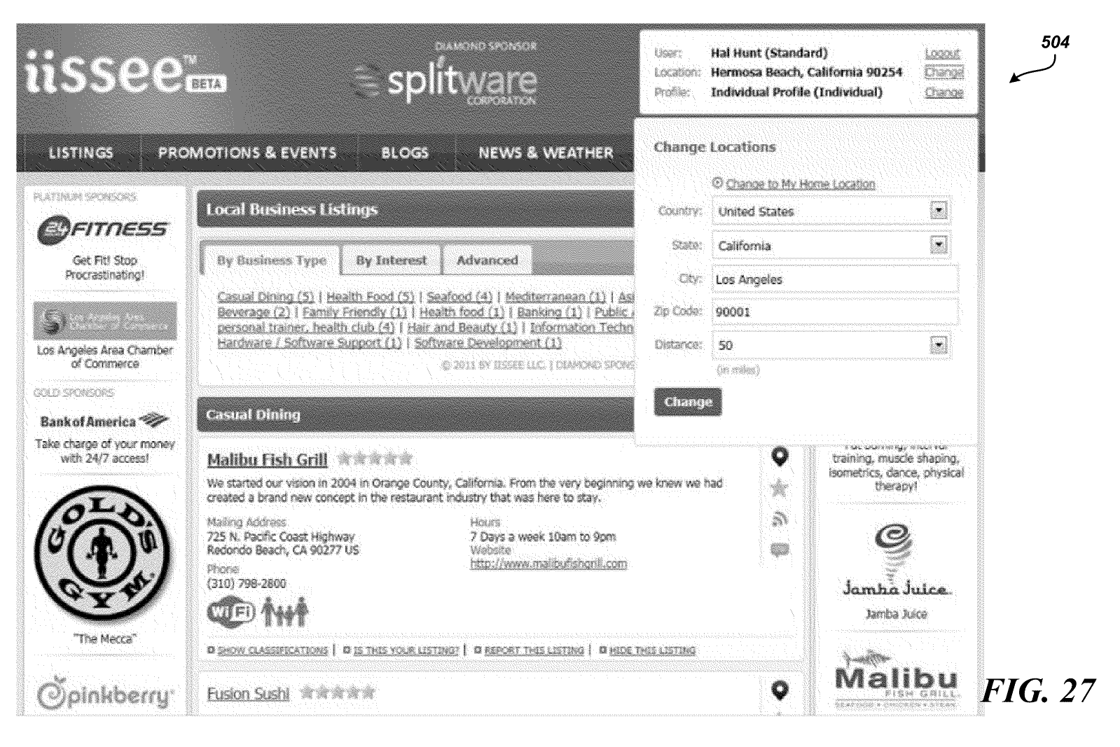

FIGS. 26 and 27 show alternative user interfaces 504 for allowing the user to change the active user profile 132 or the active location for generating the local, targeted listings 128, according to further embodiments.

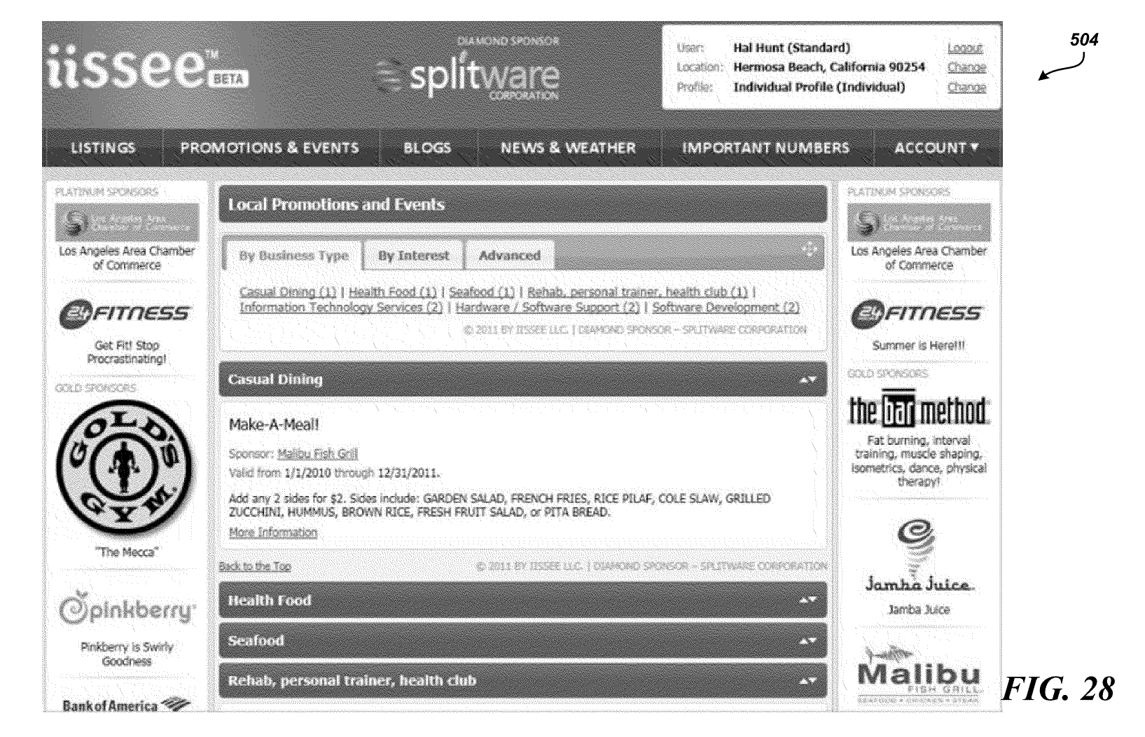

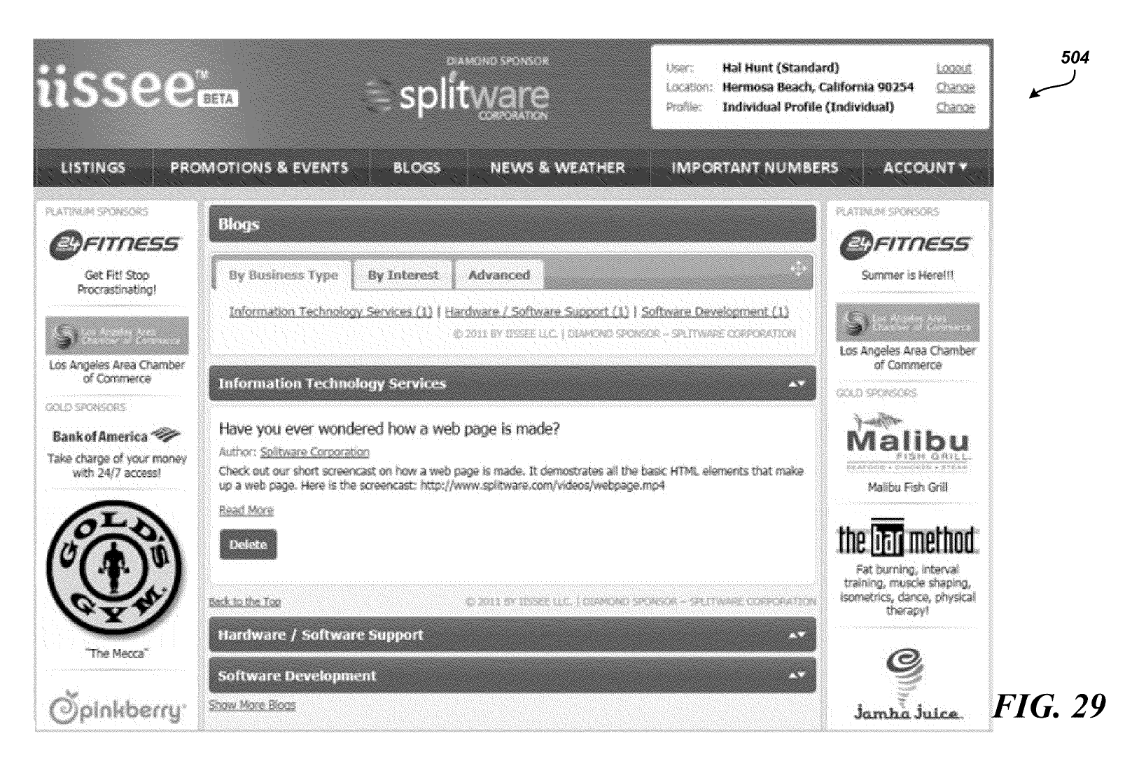

FIGS. 28 and 29 show alternative user interfaces 504 for displaying, filtering, and sorting targeted listings 128 to a user 102, according to further embodiments. These figures further show the collapsing and expanding of business classification groupings in the list, as well as the display of ads 134 to the user 102 at various positions corresponding to various levels of participation of the associated businesses.

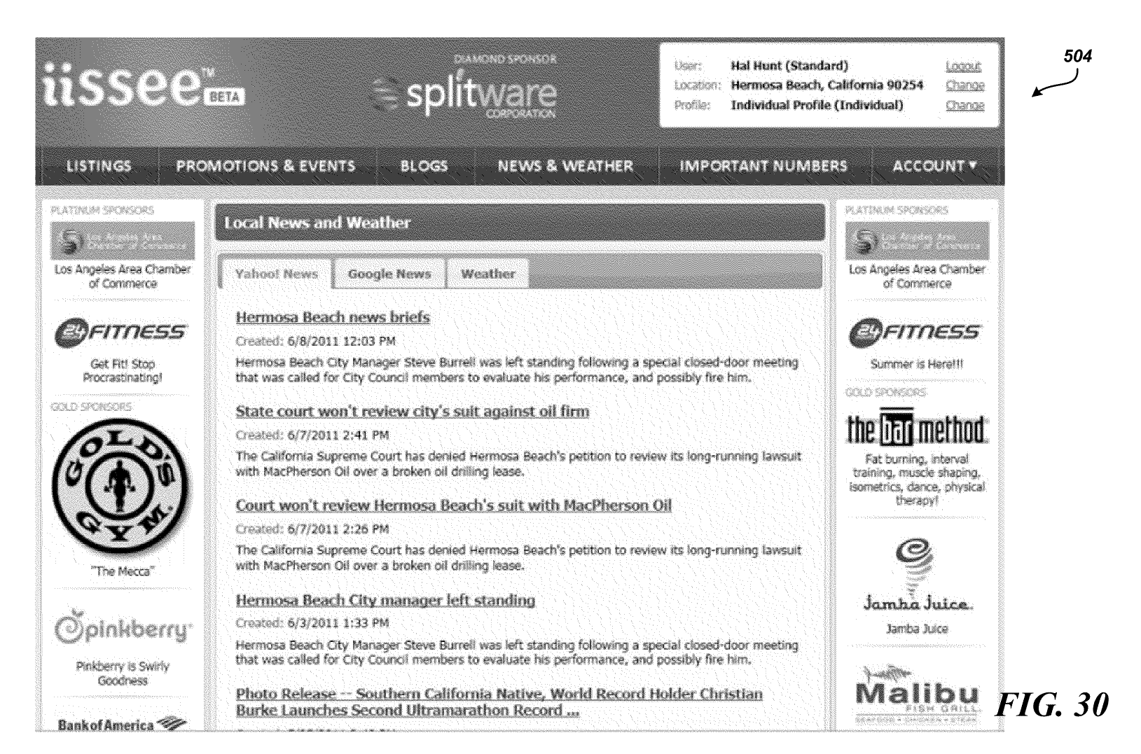

FIG. 30 shows an alternative user interface 504 for displaying localized external content to a user 102, according to further embodiments.

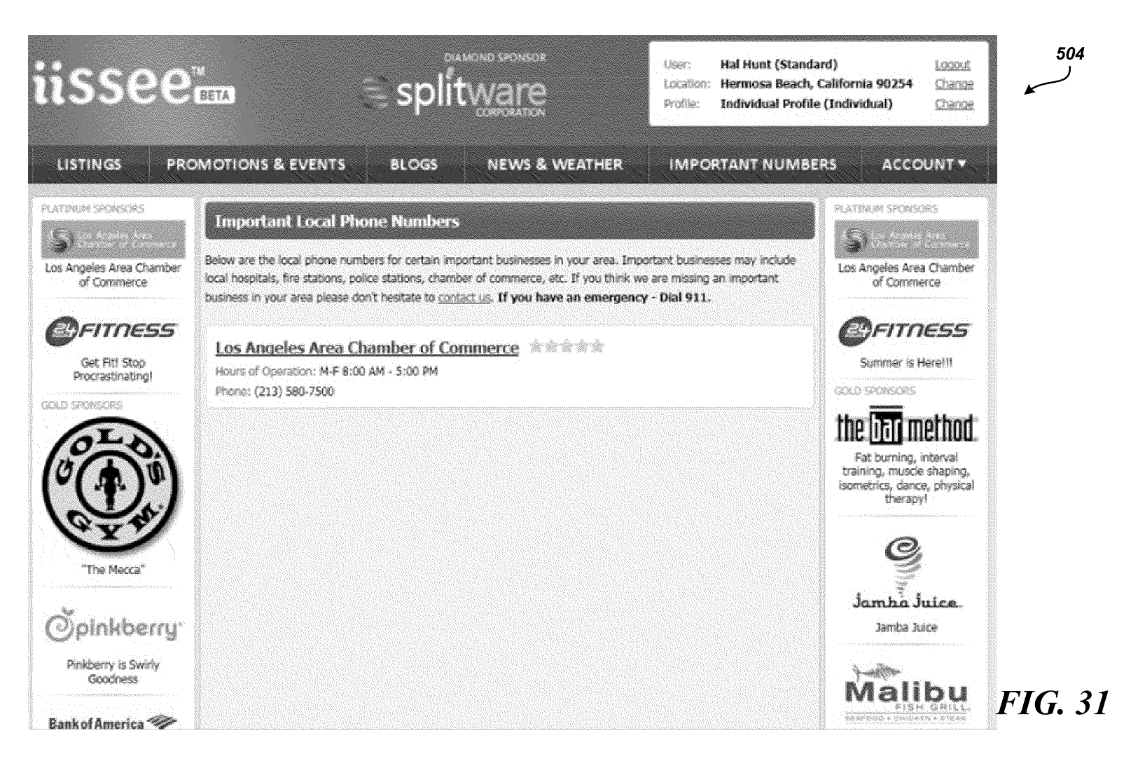

FIG. 31 shows an example user interface 504 for displaying important local phone numbers to the user 102, according to one embodiment.

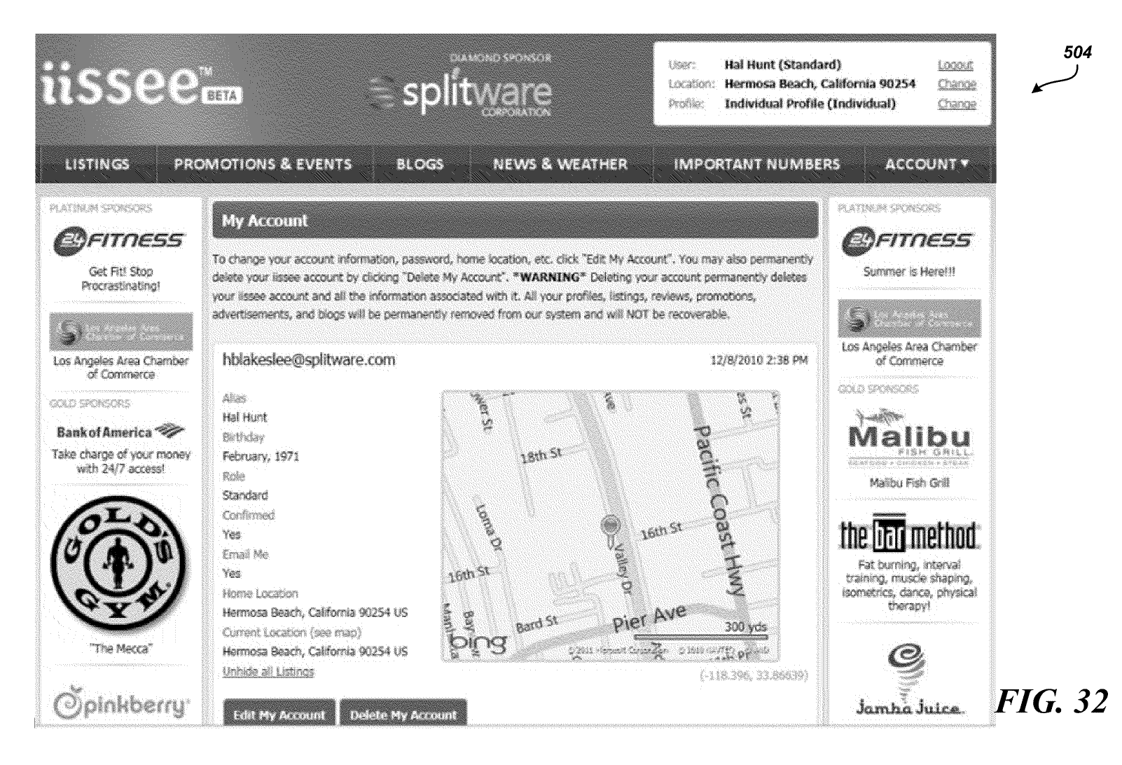

FIG. 32 shows an alternative user interface 504 for modifying the user's account details, according to further embodiments.

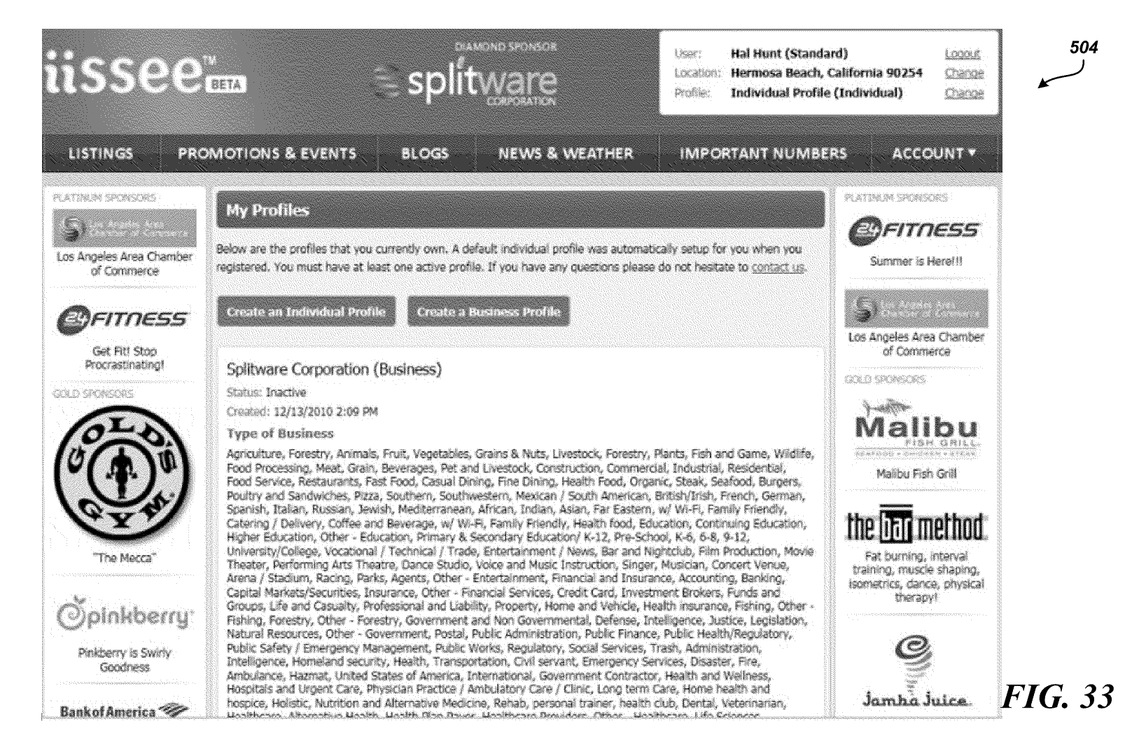

FIG. 33 shows an alternative user interface 504 for creating and/or editing a user profile, including a detailed but non-limiting list of business-type classifications that may be selected by the business user 102, according to further embodiments.

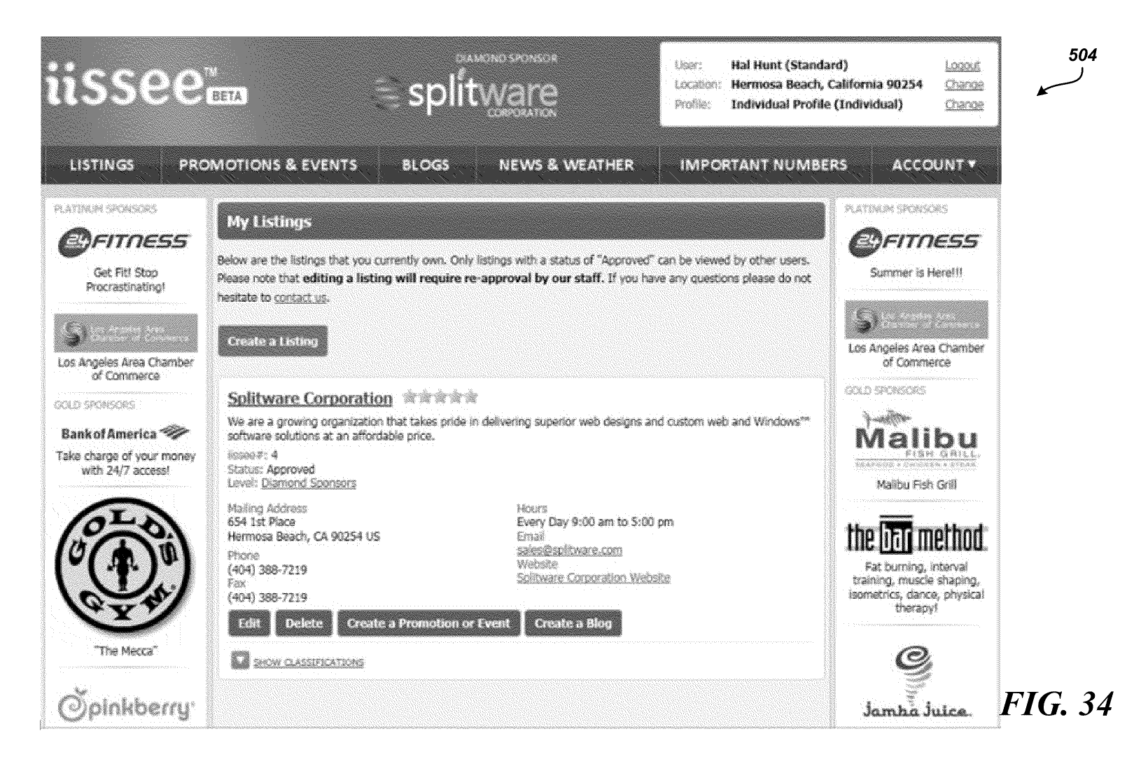

FIG. 34 shows an alternative user interface 504 for viewing details of a listings, specials, deals, or promotions, and blog entries, according to further embodiments.

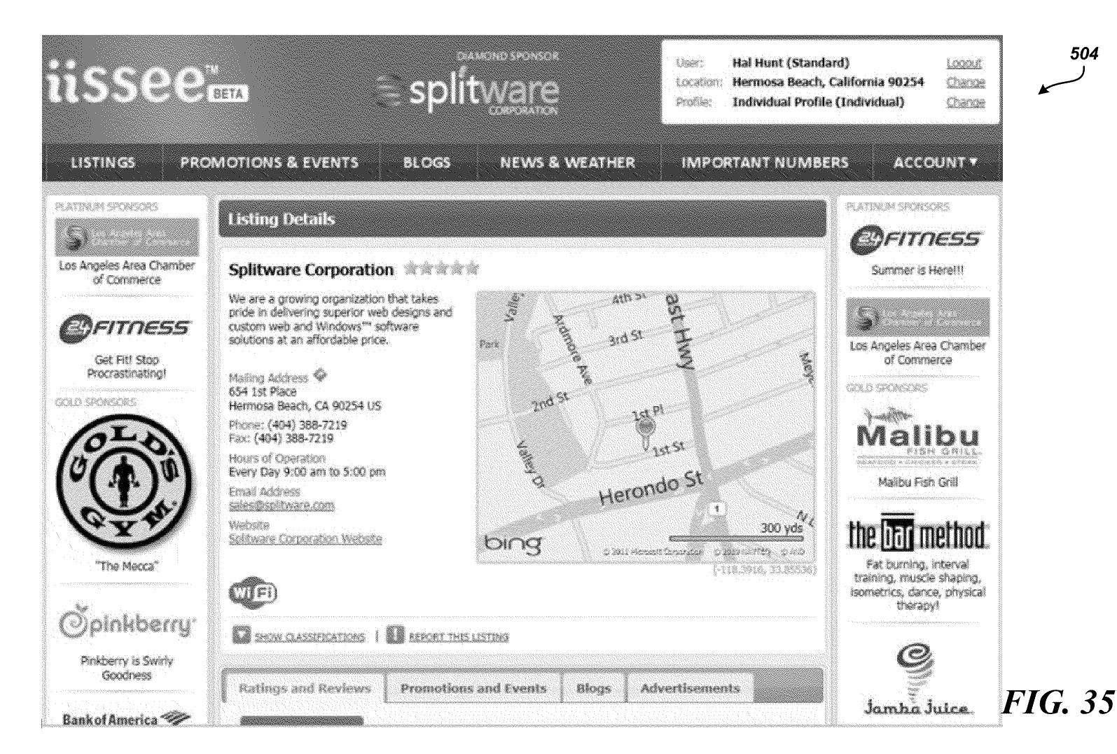

FIG. 35 shows an alternative user interface 504 containing details regarding a business listed in the local listings provider system 120, according to further embodiments.

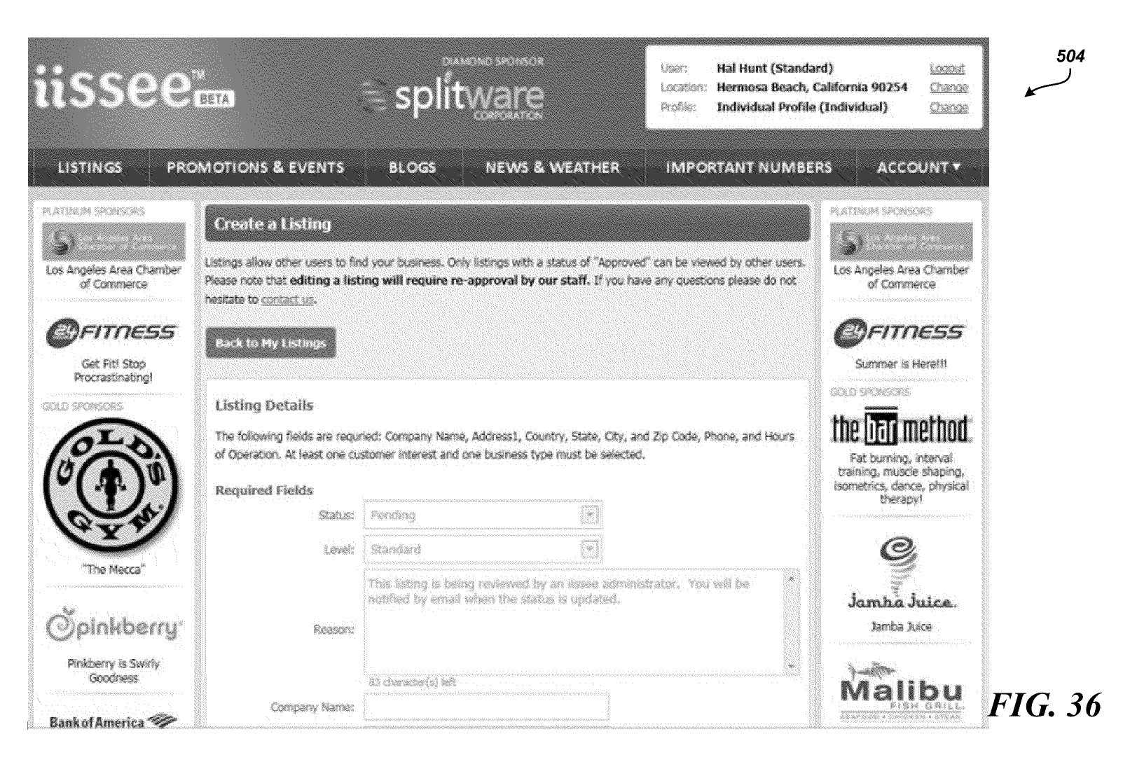

FIG. 36 shows a user interface 504 for specifying the details in a business listing, according to one embodiment.

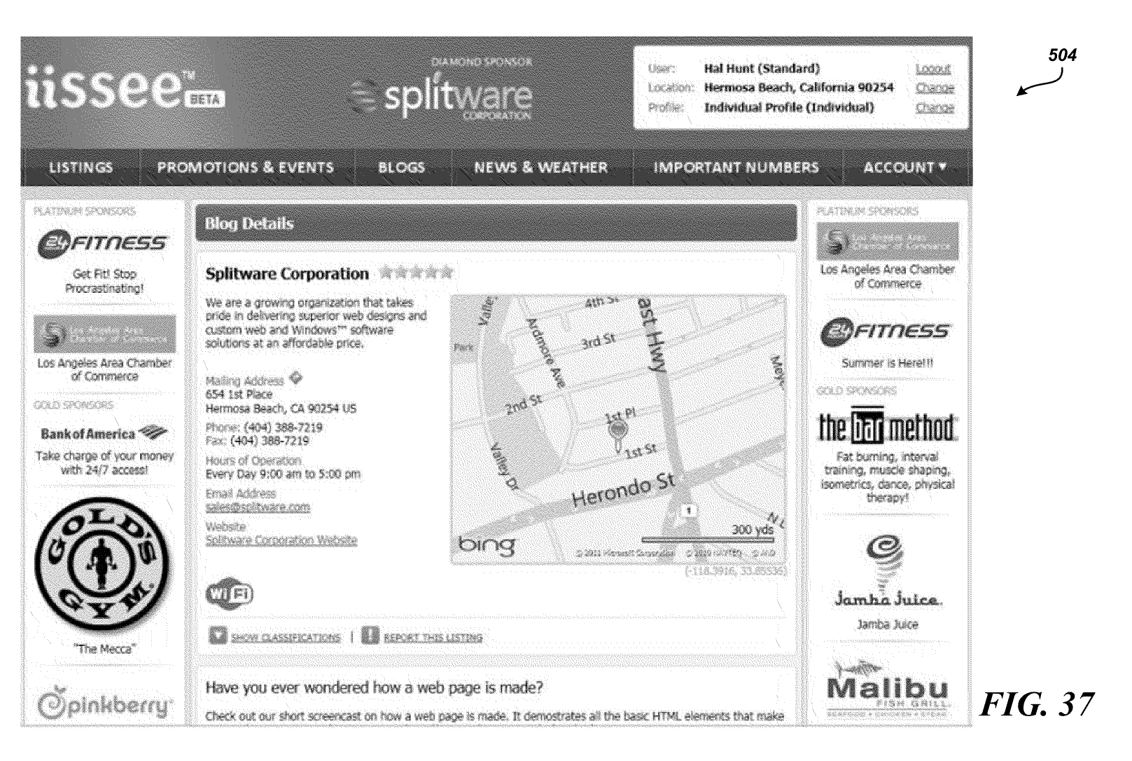

FIG. 37 shows an alternative user interface 504 for displaying a blog entry for a business, according to further embodiments.

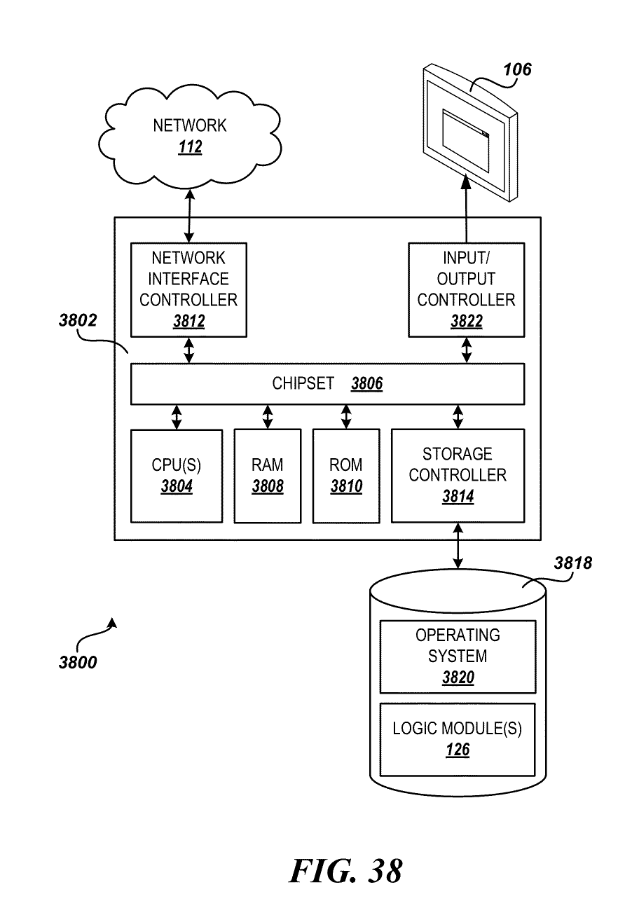

FIG. 38 shows an example computer architecture 3800 for a computer 3802 capable of executing the software components described herein for or targeting listings based on user-supplied profile and interest data, in the manner presented above. The computer architecture 3800 shown in FIG. 38 illustrates a conventional server computer, workstation, desktop computer, laptop, network appliance, personal digital assistant (“PDA”), digital cellular phone, or other computing device, and may be utilized to execute any aspects of the software components presented herein described as executing on the application servers 122, user computer 104, or other computing platform.

The computer 3802 includes a baseboard, or “motherboard,” which is a printed circuit board to which a multitude of components or devices may be connected by way of a system bus or other electrical communication paths. In one illustrative embodiment, one or more central processing units (“CPUs”) 3804 operate in conjunction with a chipset 3806. The CPUs 3804 are standard programmable processors that perform arithmetic and logical operations necessary for the operation of the computer 3802.

The CPUs 3804 perform the necessary operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 3806 provides an interface between the CPUs 3804 and the remainder of the components and devices on or connected to the baseboard. The chipset 3806 may provide an interface to a random access memory (“RAM”) 3808, used as the main memory in the computer 3802. The chipset 3806 may further provide an interface to a computer-readable storage medium such as a read-only memory (“ROM”) 3810 or non-volatile RAM (“NVRAM”) for storing basic routines that help to startup the computer 3802 and to transfer information between the various components and devices. The ROM 3810 or NVRAM may also store other software components necessary for the operation of the computer 3802 in accordance with the embodiments described herein.

According to various embodiments, the computer 3802 may operate in a networked environment using logical connections to remote computing devices and computer systems through the network 112. The chipset 3806 includes functionality for providing network connectivity through a network interface controller (“NIC”) 3812, such as a gigabit Ethernet adapter. The NIC 3812 is capable of connecting the computer 3802 to other computing devices over the network 112, such as the user computer 104, a data storage system, other application servers 122, and the like. It should be appreciated that any number of NICs 3812 may be present in the computer 3802, connecting the computer to other types of networks and remote computer systems.

The computer 3802 may be connected to a mass storage device 3818 that provides non-volatile storage for the computer. The mass storage device 3818 may store system programs, application programs, other program modules, and data, which are described in greater detail herein. The mass storage device 3818 may be connected to the computer 3802 through a storage controller 3814 connected to the chipset 3806. The mass storage device 3818 may consist of one or more physical storage units. The storage controller 3814 may interface with the physical storage units through a serial attached SCSI (“SAS”) interface, a serial advanced technology attachment (“SATA”) interface, a fiber channel (“FC”) interface, or other standard interface for physically connecting and transferring data between computers and physical storage devices.

The computer 3802 may store data on the mass storage device 3818 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 3818 is characterized as primary or secondary storage, and the like. For example, the computer 3802 may store information to the mass storage device 3818 by issuing instructions through the storage controller 3814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 3802 may further read information from the mass storage device 3818 by detecting the physical states or characteristics of one or more particular locations within the physical storage units.

In addition to the mass storage device 3818 described above, the computer 3802 may have access to other computer-readable storage medium to store and retrieve information, such as program modules, data structures, or other data. It should be appreciated by those skilled in the art that computer-readable media may be any available media that can be accessed by the computer 3802, including computer-readable storage media and communications media. Communications media includes transitory signals. Computer-readable storage media may include volatile and non-volatile, removable and non-removable media implemented in any method or technology, but does not encompass transitory signals. For example, computer-readable storage media may include RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information.

The mass storage device 3818 may store an operating system 3820 utilized to control the operation of the computer 3802. According to one embodiment, the operating system comprises the LINUX operating system. According to another embodiment, the operating system comprises the WINDOWS® SERVER operating system from MICROSOFT Corporation of Redmond, Wash. According to further embodiments, the operating system may comprise the UNIX or SOLARIS operating systems. It should be appreciated that other operating systems may also be utilized.

The mass storage device 3818 may store other system or application programs and data utilized by the computer 3802, such as the logic modules 126 described above in regard to FIG. 1. In one embodiment, the mass storage device 3818 or other computer-readable storage media may be encoded with computer-executable instructions that, when loaded into the computer 3802, may transform the computer from a general-purpose computing system into a special-purpose computer capable of implementing the embodiments described herein. These computer-executable instructions transform the computer 3802 by specifying how the CPUs 3804 transition between states, as described above. According to one embodiment, the computer 3802 may have access to computer-readable storage media storing computer-executable instructions that, when executed by the computer, perform the functions enumerated in FIGS. 2 and 3 above.

The computer 3802 may also include an input/output controller 3822 for receiving and processing input from a number of input devices, such as a mouse, a keyboard, a touchpad, a touch screen, an electronic stylus, or other type of input device. Similarly, the input/output controller 3822 may provide output to the display 106, such as a computer monitor, a flat-panel display, a digital projector, a printer, a plotter, or other type of output device. It will be appreciated that the computer 3802 may not include all of the components shown in FIG. 38, may include other components that are not explicitly shown in FIG. 38, or may utilize an architecture completely different than that shown in FIG. 38.

In other embodiments, the local listings provider system 120 can additionally or alternatively provide services such as those described herein in other geographic or locality contexts. Listings may be provided for a specific locale, such as a local region comprising multiple counties, a hyper-local region defined by a particular city or area within a city, an ultra-local region defined inside a particular business or venue such as a shopping mall, convention hall, or theme park, and the like. An ultra-local region may also be defined by an area within a specified radius of a particular business, for instance within a one-block radius of a particular store. In addition to geographic radius, a locale may be defined based on other metrics, such as population density or concentration around a particular location, business, or entity.

Further examples of geographic or locality contexts may include:
1. EPCOT park in WALT DISNEY WORLD® resort (a park made up of areas representing multiple countries of the world) could have a focused or private version or module of the system so users could access information about the shops, restaurants vendors, etc. from the various ‘countries’ that match their user profiles.
2. A region that encompasses a large number of entertainment venues could have a focused version or module of the system such that users with concentrations in entertainment could have a focused presentation of thrill rides or amusement parks, filtered and sorted by thrill level, age appropriateness, type of rides, etc.; or New York plays, shows, parks, shopping, etc. with filtering and sorting by types of shows, ages of patrons, styles, etc.
3. A private internal version or module can be constructed or adapted for large businesses, organizations, charities or governments that have internal services, groups, products, raw materials, varying types of workers or members, etc. with filtering by individual, job function, department, product, service, etc. as a useful tool for providing personalized listing, reference, directory, etc. information.
4. A private internal version or module can be constructed or adapted for chambers of commerce or other trade organizations.
5. A user could use the system to see the concentration of entities that meet their profile that are within a user specified radius around hotels to assist them in making their lodging decisions. Additionally, should a user desire, their profile could be conveyed to travel sites to assist in the booking.
6. A film production company could use the system to pick cities/areas to house their cast and crew that has the businesses to support the number of cast and crew.
7. A film production company could build the profiles of a character (for example a man in the late 1940's coming home from the war) and thus get additional info on possible scene locations.
8. A university could have a dual use, private version, to provide new students with community and business information matching their profile and to provide them with university information that would match their student/academic profile of the student.
9. A convention goer with a business/convention profile could use the system with the geographic area of the inside of the convention hall and the listings provided by the exhibitors.

In additional embodiments, various filtering and sorting processes or schemes could be utilized by the local listings provider system 120 to filter and sort the listings provided to a user. In the examples provided below, filtering ‘criteria’ refer to the traits, characteristics, preferences, demographics, habits, business types and classifications desired in the personalized listing, etc. Examples of filtering processes or schemes include:

Simple:
Include listings that match any user inclusion selected criteria
Include all listings that match any user exclusion selected criteria

Compound:
Include listings that meet the AND criteria

Complex:
Required inclusion
When a listing meets A but NOT when listing also meets B
When a listing meets A AND B but NOT when listing also meets C
Weighted:
   Fuzzy:
      Criteria A is more important than criteria B but both are inclusive
   Value weighting:
      Criteria A has an inclusion importance rank of 8 and criteria B has an inclusion importance rank of 5 but both are inclusive
         In this scenario the personalized listing presentation could simply include the listing or also include annotation regarding the importance ranking
      Criteria A has an inclusion importance rank of 8 but an exclusion importance of 1
         In this scenario, the system (based on user specified presentation preferences) could exclude the business listing all together or include the listing but with an annotation regarding the inclusion and exclusion ranks

Examples of sorting processes or schemes include:

Alphabetical

By user reviews

By distance

By chamber or BBB member

By varying calculations or correlations of matched profile items.

According to another embodiment, the local listings provider system 120 would support sub-profiles types, such as a “mall/shopping area” or “travel/airport.” For example, a user may set up a “mail/shopping” sub-profile with combined characteristics of family and/or friends to be used in a shopping trip for Christmas gifts. The user can enter the system to activate the sub-profile, or the sub-profile may be activated when the user enters a shopping mall or other shopping district (as designated in the local listings provider system 120). For example, on the outside of every entrance (including external store entrances) to a mall or shopping area, there may be a quick response “QR” code or other identifier that identifies the mall/shopping area. All retail outlets, restaurants, services, and other businesses in the mall may be tied to the identifier. The user may use a camera on a smart phone or other mobile device scan the QR code and the local listings provider system 120 would correlate the stores from the mall or shopping area to the “mall/shopping” sub-profile of the user and present them to the user in a static or interactive format with store, service, food court, restaurant, descriptions, listing information, maps, mall or area specials and deals, and the like. There may also be integration with the mall/area code or identifier and the codes or identifiers on the specific stores within the mall or area. These store identifiers could tie into the specific businesses' specials and deals, store inventories, social media, and the like. The sub-profiles could be tied to any type of area or district, including airports, shopping centers, strip malls, Pier Park in Panama City, Fla., Fifth Avenue in New York, N.Y., and the like.

Based on the foregoing, it should be appreciated that technologies for targeting listings based on user-supplied profile and interest data are provided herein. Although the subject matter presented herein has been described in language specific to computer structural features, methodological acts, and computer-readable storage media, it is to be understood that the invention is not necessarily limited to the specific features, acts, or media described herein. Rather, the specific features, acts, and mediums are disclosed as example forms of implementing the invention.

The subject matter described above is provided by way of illustration only and should not be construed as limiting. Various modifications and changes may be made to the subject matter described herein without following the example embodiments and applications illustrated and described, and without departing from the true spirit and scope of the present invention.

What is claimed is:

1. A computer-implemented method for targeting listings based on user-supplied profile and interest data, the method comprising:
receiving user-supplied profile and interest data from a user;
generating targeted business listings for the user based on the user-supplied profile and interest data; and
providing the targeted business listings to the user.

2. The computer implemented method of claim 1, further comprising:
receiving target interest data associated with a business; and
generating the targeted business listings by matching the user-supplied profile and interest data with the received target interest data associated with the business.

3. The computer-implemented method of claim 2, wherein generating the targeted business listings comprises excluding business listings for a business associated with targeted interest data that matches the user-supplied profile and interest data.

4. The computer-implemented method of claim 1, wherein the profile and interest data comprises at least one of user demographics, interests, traits, and characteristics.

5. The computer-implemented method of claim 1, comprising receiving profile and interest data from the user for a plurality of named profiles.

6. The computer-implemented method of claim 5, wherein each of the plurality of named profiles is associated with a persona.

7. The computer-implemented method of claim 5, wherein each of the plurality of named profiles is associated with an activity.

8. The computer-implemented method of claim 5, wherein a user interface presented to the user indicates a currently active named profile.

9. The computer-implemented method of claim 1, further comprising:
receiving location data from the user; and
generating the targeted business listings further based on the received location data.

10. The computer-implemented method of claim 9, wherein the location data comprises a zip code and a radius.

11. A system for targeting listings based on user-supplied profile and interest data, the system comprising:
one or more processing units;
a memory device operatively coupled to the one or more processing units; and
a logic module residing in the memory device and configured to cause the one or more processing units to
receive user-supplied profile and interest data from a user,
receive target interest data associated with a business,
generate targeted business listings by matching the user-supplied profile and interest data with the received target interest data associated with the business, and
provide the targeted business listings to the user.

12. The system of claim 11, wherein generating the targeted business listings comprises excluding business listings for a business associated with targeted interest data that matches the user-supplied profile and interest data.

13. The system of claim 11, wherein providing the targeted business listings to the user comprises displaying the targeted business listings in a user interface presented to the user on a display connected to a user computer.

14. The system of claim 13, wherein the user can indicate one or more of the targeted business listings be hidden from the user in the user interface.

15. A computer-readable storage medium having stored thereon computer-executable instructions which, when executed by one or more processors, cause a computer to:
receive user-supplied profile and interest data associated with each of a plurality of named profiles from a user;
receive a selection of a currently active profile from the user, the currently active profile comprising one of the plurality of named profiles from the user;
generate targeted business listings for the user based on the user-supplied profile and interest data for the currently active profile; and
provide the targeted business listings to the user in a user interface presented to the user on a display connected to a user computer.

16. The computer-readable storage medium of claim 15, wherein the each of the plurality of named profiles is associated with at least one of a persona or an activity.

17. The computer-readable storage medium of claim 15, further comprising computer-executable instructions which, when executed by the one or more processors, cause the computer to present an indication in the user interface of the currently active profile.

18. The computer-readable storage medium of claim 15, wherein the user can indicate one or more of the targeted business listings be hidden from the user in the user interface.

19. The computer-readable storage medium of claim 15, further comprising computer-executable instructions which, when executed by the one or more processors, cause the computer to:
receive external content;
filter the external content based on the currently active profile; and
provide the filtered external content to the user in the user interface.

20. The computer-readable storage medium of claim 15, further comprising computer-executable instructions which, when executed by the one or more processors, cause the computer to provide additional targeted content to the user with the target business listings, the additional targeted content comprising at least one of advertisements, promotions, crowd-sourced content, and business classification data.
